(19) United States
(12) Patent Application Publication
(10) Pub. No.: US 2023/0087449 A1
(43) Pub. Date: Mar. 23, 2023

(54) MODULATION AND CODING SCHEME DESIGN FOR EXTENDED RANGE APPLICATIONS

(71) Applicants: Qinghua LI, San Ramon, CA (US); Juan FANG, Portland, OR (US); Assaf GUREVITZ, Ramat Hasharon (IL); Thomas J. KENNEY, Portland, OR (US); Robert STACEY, Portland, OR (US)

(72) Inventors: Qinghua LI, San Ramon, CA (US); Juan FANG, Portland, OR (US); Assaf GUREVITZ, Ramat Hasharon (IL); Thomas J. KENNEY, Portland, OR (US); Robert STACEY, Portland, OR (US)

(21) Appl. No.: 18/073,281

(22) Filed: Dec. 1, 2022

(51) Int. Cl. H04L 27/26

(52) U.S. Cl. CPC H04L 27/2646; H04L 27/2605

(57) ABSTRACT

This disclosure describes systems, methods, and devices related to extended range modulation and coding scheme (MCS). A device may generate a first orthogonal frequency-division multiplexing (OFDM) signal to be transmitted in a frequency band. The device may generate a second OFDM signal to be transmitted in the frequency band, wherein the second OFDM signal is a duplicate of the first signal. The device may assign a reduced number of guard intervals (GIs) to the first OFDM signal and the second OFDM signal. The device may cause to send the first OFDM signal and the second OFDM signal using the frequency band.

### TECHNICAL FIELD

This disclosure generally relates to systems and methods for wireless communications and, more particularly, to modulation and coding scheme (MCS) design for extended range applications.

### BACKGROUND

Wireless devices are becoming widely prevalent and are increasingly requesting access to wireless channels. The Institute of Electrical and Electronics Engineers (IEEE) is developing one or more standards that utilize Orthogonal Frequency-Division Multiple Access (OFDMA) in channel allocation.

### BRIEF DESCRIPTION OF THE DRAWINGS

FIG. 1 is a network diagram illustrating an example network environment for extended range modulation and coding scheme (MCS), in accordance with one or more example embodiments of the present disclosure.

FIG. 1(a) depicts an illustrative schematic diagram for extended range MCS, in accordance with one or more example embodiments of the present disclosure.

FIG. 2 depicts an illustrative schematic diagram for extended range MCS, in accordance with one or more example embodiments of the present disclosure.

FIG. 3 depicts an illustrative schematic diagram for extended range MCS, in accordance with one or more example embodiments of the present disclosure.

FIGS. 4-7 depict illustrative schematic diagrams for extended range MCS, in accordance with one or more example embodiments of the present disclosure.

FIGS. 8(a), 8(b), and 9 depict illustrative schematic diagrams for extended range MCS, in accordance with one or more example embodiments of the present disclosure.

FIGS. 10, 11(a), 11(b), and 12 depict illustrative schematic diagrams for extended range MCS, in accordance with one or more example embodiments of the present disclosure.

FIG. 13 illustrates a flow diagram of illustrative process for an illustrative extended range MCS system, in accordance with one or more example embodiments of the present disclosure.

FIG. 14 illustrates a functional diagram of an exemplary communication station that may be suitable for use as a user device, in accordance with one or more example embodiments of the present disclosure.

FIG. 15 illustrates a block diagram of an example machine upon which any of one or more techniques (e.g., methods) may be performed, in accordance with one or more example embodiments of the present disclosure.

FIG. 16 is a block diagram of a radio architecture in accordance with some examples.

FIG. 17 illustrates an example front-end module circuitry for use in the radio architecture of FIG. 16, in accordance with one or more example embodiments of the present disclosure.

FIG. 18 illustrates an example radio IC circuitry for use in the radio architecture of FIG. 16, in accordance with one or more example embodiments of the present disclosure.

FIG. 19 illustrates an example baseband processing circuitry for use in the radio architecture of FIG. 16, in accordance with one or more example embodiments of the present disclosure.

### DETAILED DESCRIPTION

The following description and the drawings sufficiently illustrate specific embodiments to enable those skilled in the art to practice them. Other embodiments may incorporate structural, logical, electrical, process, algorithm, and other changes. Portions and features of some embodiments may be included in, or substituted for, those of other embodiments. Embodiments set forth in the claims encompass all available equivalents of those claims.

Although 802.11b is more than 20 years old, it is still widely used for long range communications in WLAN. However, it has certain downsides, e.g., weak channel coding and the coexistence issue with mainstream OFDM-based systems. There is a need to replace it with an OFDM-based system with similar range coverage, which is about 9 dB better than the existing 20 MHz MCS 0 of OFDM-based 802.11a, the 6 Mbps mode.

High efficiency (HE) extended range (ER) single user (SU) physical layer (PHY) convergence protocol data unit (PPDU) format was defined in 802.1 lax. Both short training field (STF) and long training field (LTF) will be boosted with 3 dB, then both HE-SIG-A1 and HE-SIG-A2 are repeated twice, which is HE-SIG-A1, HE-SIG-A1-R, HE-SIG-A2 and HE-SIG-A2-R. HE-SIG-A1-R is modulated with quadrature binary phase-shift keying (QBPSK) to indicate the extended range mode. For the data, the HE ER SU PPDU supports only a single 242-tone or 106-tone RU. An HE ER SU PPDU with a 242-tone RU shall be transmitted with only the MCS0, 1, and 2 with a single spatial stream. An HE ER SU PPDU with a 106-tone RU shall be transmitted with only the MCS0 with a single spatial stream and the 106-tone RU allocation within the 20 MHz tone plan is fixed as the one that is higher in the frequency.

The ER preamble was also defined in 802.11be. Both STF and LTF will be boosted with 3 dB, then both U-SIG1 and U-SIG2 are repeated twice to improve the performance. The U-SIG-sym-1-R is transmitted with QBPSK, which is used to indicate the extended range mode. However, the ER data format was not introduced in 802.11be.

Example embodiments of the present disclosure relate to systems, methods, and devices for modulation and coding scheme (MCS) design for extended range application.

In one embodiment, an extended range MCS system may facilitate modulation schemes for supporting the extended range feature of Wi-Fi 8, where the modulation schemes are used for the transmission of the preamble and data.

The above descriptions are for purposes of illustration and are not meant to be limiting. Numerous other examples, configurations, processes, algorithms, etc., may exist, some of which are described in greater detail below. Example embodiments will now be described with reference to the accompanying figures.

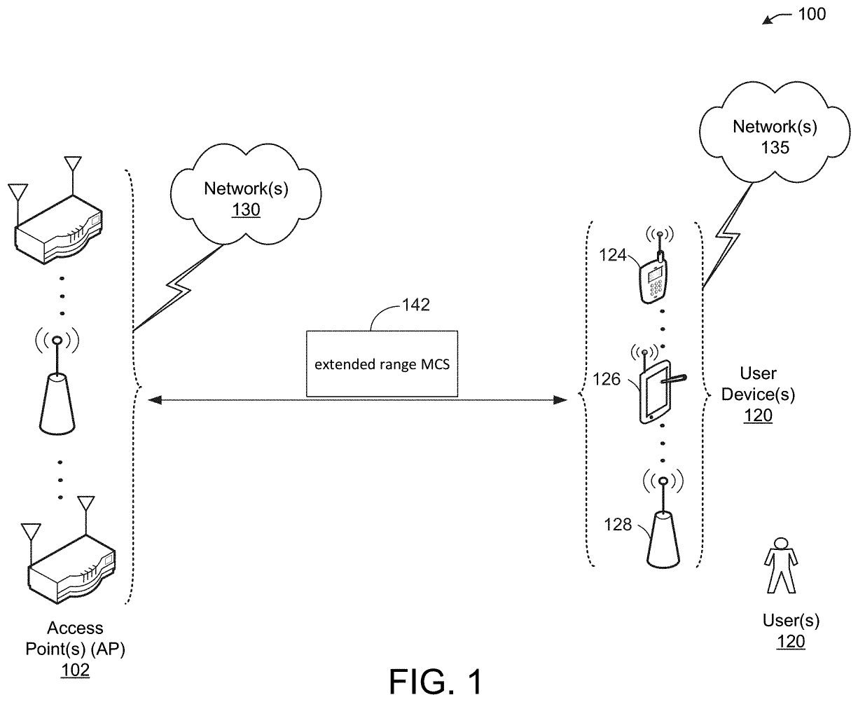

FIG. 1 is a network diagram illustrating an example network environment of extended range MCS, according to some example embodiments of the present disclosure. Wireless network 100 may include one or more user devices 120 and one or more access points(s) (AP) 102, which may communicate in accordance with IEEE 802.11 communication standards. The user device(s) 120 may be mobile devices that are non-stationary (e.g., not having fixed locations) or may be stationary devices.

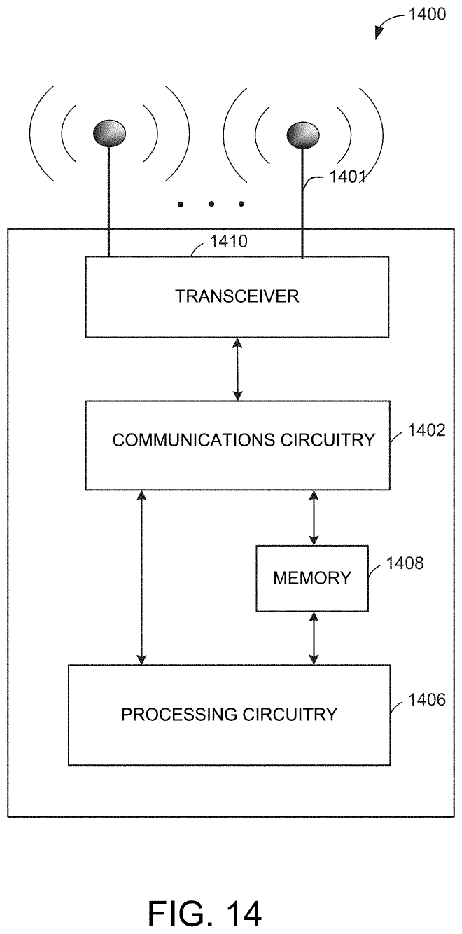

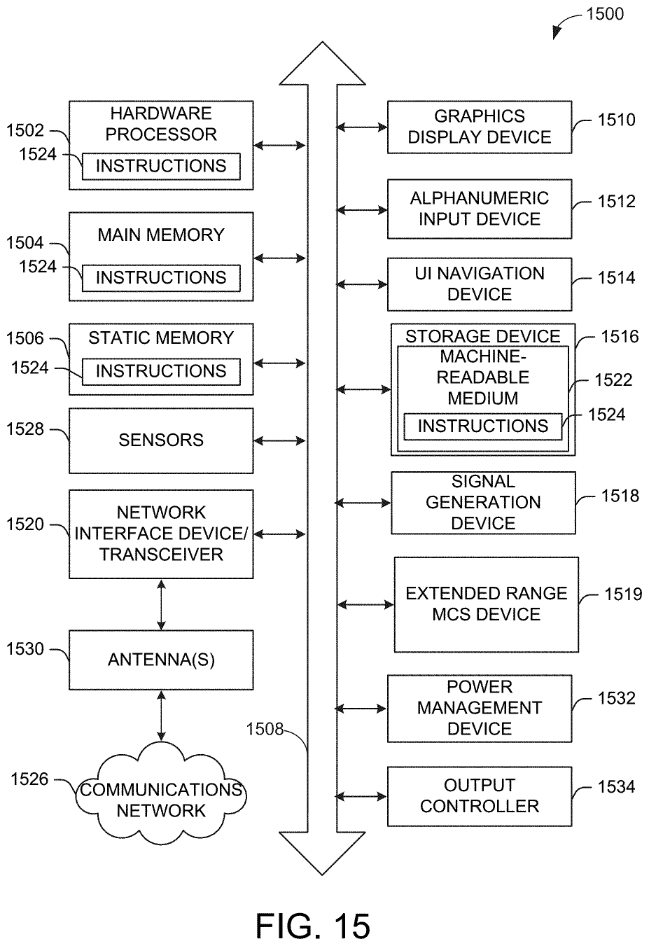

In some embodiments, the user devices 120 and the AP 102 may include one or more computer systems similar to that of the functional diagram of FIG. 14 and/or the example machine/system of FIG. 15.

One or more illustrative user device(s) 120 and/or AP(s) 102 may be operable by one or more user(s) 110. It should be noted that any addressable unit may be a station (STA). An STA may take on multiple distinct characteristics, each of which shape its function. For example, a single addressable unit might simultaneously be a portable STA, a quality-of-service (QoS) STA, a dependent STA, and a hidden STA. The one or more illustrative user device(s) 120 and the AP(s) 102 may be STAs. The one or more illustrative user device(s) 120 and/or AP(s) 102 may operate as a personal basic service set (PBSS) control point/access point (PCP/AP). The user device(s) 120 (e.g., 124, 126, or 128) and/or AP(s) 102 may include any suitable processor-driven device including, but not limited to, a mobile device or a non-mobile, e.g., a static device. For example, user device(s) 120 and/or AP(s) 102 may include, a user equipment (UE), a station (STA), an access point (AP), a software enabled AP (SoftAP), a personal computer (PC), a wearable wireless device (e.g., bracelet, watch, glasses, ring, etc.), a desktop computer, a mobile computer, a laptop computer, an Ultrabook™ computer, a notebook computer, a tablet computer, a server computer, a handheld computer, a handheld device, an internet of things (IoT) device, a sensor device, a PDA device, a handheld PDA device, an on-board device, an off-board device, a hybrid device (e.g., combining cellular phone functionalities with PDA device functionalities), a consumer device, a vehicular device, a non-vehicular device, a mobile or portable device, a non-mobile or non-portable device, a mobile phone, a cellular telephone, a PCS device, a PDA device which incorporates a wireless communication device, a mobile or portable GPS device, a DVB device, a relatively small computing device, a non-desktop computer, a “carry small live large” (CSLL) device, an ultra mobile device (UMD), an ultra mobile PC (UMPC), a mobile internet device (MID), an “origami” device or computing device, a device that supports dynamically composable computing (DCC), a context-aware device, a video device, an audio device, an A/V device, a set-top-box (STB), a blu-ray disc (BD) player, a BD recorder, a digital video disc (DVD) player, a high definition (HD) DVD player, a DVD recorder, a HD DVD recorder, a personal video recorder (PVR), a broadcast HD receiver, a video source, an audio source, a video sink, an audio sink, a stereo tuner, a broadcast radio receiver, a flat panel display, a personal media player (PMP), a digital video camera (DVC), a digital audio player, a speaker, an audio receiver, an audio amplifier, a gaming device, a data source, a data sink, a digital still camera (DSC), a media player, a smartphone, a television, a music player, or the like. Other devices, including smart devices such as lamps, climate control, car components, household components, appliances, etc. may also be included in this list.

As used herein, the term “Internet of Things (IoT) device” is used to refer to any object (e.g., an appliance, a sensor, etc.) that has an addressable interface (e.g., an Internet protocol (IP) address, a Bluetooth identifier (ID), a near-field communication (NFC) ID, etc.) and can transmit information to one or more other devices over a wired or wireless connection. An IoT device may have a passive communication interface, such as a quick response (QR) code, a radio-frequency identification (RFID) tag, an NFC tag, or the like, or an active communication interface, such as a modem, a transceiver, a transmitter-receiver, or the like. An IoT device can have a particular set of attributes (e.g., a device state or status, such as whether the IoT device is on or off, open or closed, idle or active, available for task execution or busy, and so on, a cooling or heating function, an environmental monitoring or recording function, a light-emitting function, a sound-emitting function, etc.) that can be embedded in and/or controlled/monitored by a central processing unit (CPU), microprocessor, ASIC, or the like, and configured for connection to an IoT network such as a local ad-hoc network or the Internet. For example, IoT devices may include, but are not limited to, refrigerators, toasters, ovens, microwaves, freezers, dishwashers, dishes, hand tools, clothes washers, clothes dryers, furnaces, air conditioners, thermostats, televisions, light fixtures, vacuum cleaners, sprinklers, electricity meters, gas meters, etc., so long as the devices are equipped with an addressable communications interface for communicating with the IoT network. IoT devices may also include cell phones, desktop computers, laptop computers, tablet computers, personal digital assistants (PDAs), etc. Accordingly, the IoT network may be comprised of a combination of “legacy” Internet-accessible devices (e.g., laptop or desktop computers, cell phones, etc.) in addition to devices that do not typically have Internet-connectivity (e.g., dishwashers, etc.).

The user device(s) 120 and/or AP(s) 102 may also include mesh stations in, for example, a mesh network, in accordance with one or more IEEE 802.11 standards and/or 3GPP standards.

Any of the user device(s) 120 (e.g., user devices 124, 126, 128), and AP(s) 102 may be configured to communicate with each other via one or more communications networks 130 and/or 135 wirelessly or wired. The user device(s) 120 may also communicate peer-to-peer or directly with each other with or without the AP(s) 102. Any of the communications networks 130 and/or 135 may include, but not limited to, any one of a combination of different types of suitable communications networks such as, for example, broadcasting networks, cable networks, public networks (e.g., the Internet), private networks, wireless networks, cellular networks, or any other suitable private and/or public networks. Further, any of the communications networks 130 and/or 135 may have any suitable communication range associated therewith and may include, for example, global networks (e.g., the Internet), metropolitan area networks (MANs), wide area networks (WANs), local area networks (LANs), or personal area networks (PANs). In addition, any of the communications networks 130 and/or 135 may include any type of medium over which network traffic may be carried including, but not limited to, coaxial cable, twisted-pair wire, optical fiber, a hybrid fiber coaxial (HFC) medium, microwave terrestrial transceivers, radio frequency communication mediums, white space communication mediums, ultra-high frequency communication mediums, satellite communication mediums, or any combination thereof.

Any of the user device(s) 120 (e.g., user devices 124, 126, 128) and AP(s) 102 may include one or more communications antennas. The one or more communications antennas may be any suitable type of antennas corresponding to the communications protocols used by the user device(s) 120 (e.g., user devices 124, 126 and 128), and AP(s) 102. Some non-limiting examples of suitable communications antennas include Wi-Fi antennas, Institute of Electrical and Electronics Engineers (IEEE) 802.11 family of standards compatible antennas, directional antennas, non-directional antennas, dipole antennas, folded dipole antennas, patch antennas, multiple-input multiple-output (MIMO) antennas, omnidirectional antennas, quasi-omnidirectional antennas, or the like. The one or more communications antennas may be communicatively coupled to a radio component to transmit and/or receive signals, such as communications signals to and/or from the user devices 120 and/or AP(s) 102.

Any of the user device(s) 120 (e.g., user devices 124, 126, 128), and AP(s) 102 may be configured to perform directional transmission and/or directional reception in conjunction with wirelessly communicating in a wireless network. Any of the user device(s) 120 (e.g., user devices 124, 126, 128), and AP(s) 102 may be configured to perform such directional transmission and/or reception using a set of multiple antenna arrays (e.g., DMG antenna arrays or the like). Each of the multiple antenna arrays may be used for transmission and/or reception in a particular respective direction or range of directions. Any of the user device(s) 120 (e.g., user devices 124, 126, 128), and AP(s) 102 may be configured to perform any given directional transmission towards one or more defined transmit sectors. Any of the user device(s) 120 (e.g., user devices 124, 126, 128), and AP(s) 102 may be configured to perform any given directional reception from one or more defined receive sectors.

MIMO beamforming in a wireless network may be accomplished using RF beamforming and/or digital beamforming. In some embodiments, in performing a given MIMO transmission, user devices 120 and/or AP(s) 102 may be configured to use all or a subset of its one or more communications antennas to perform MIMO beamforming.

Any of the user devices 120 (e.g., user devices 124, 126, 128), and AP(s) 102 may include any suitable radio and/or transceiver for transmitting and/or receiving radio frequency (RF) signals in the bandwidth and/or channels corresponding to the communications protocols utilized by any of the user device(s) 120 and AP(s) 102 to communicate with each other. The radio components may include hardware and/or software to modulate and/or demodulate communications signals according to pre-established transmission protocols. The radio components may further have hardware and/or software instructions to communicate via one or more Wi-Fi and/or Wi-Fi direct protocols, as standardized by the Institute of Electrical and Electronics Engineers (IEEE) 802.11 standards. In certain example embodiments, the radio component, in cooperation with the communications antennas, may be configured to communicate via 2.4 GHz channels (e.g. 802.11b, 802.11g, 802.11n, 802.11ax), 5 GHz channels (e.g. 802.11n, 802.11ac, 802.11ax, 802.11be, etc.), 6 GHz channels (e.g., 802.11ax, 802.11be, etc.), or 60 GHZ channels (e.g. 802.11ad, 802.11ay). 800 MHz channels (e.g. 802.11ah). The communications antennas may operate at 28 GHz and 40 GHz. It should be understood that this list of communication channels in accordance with certain 802.11 standards is only a partial list and that other 802.11 standards may be used (e.g., Next Generation Wi-Fi, or other standards). In some embodiments, non-Wi-Fi protocols may be used for communications between devices, such as Bluetooth, dedicated short-range communication (DSRC), Ultra-High Frequency (UHF) (e.g. IEEE 802.11af, IEEE 802.22), white band frequency (e.g., white spaces), or other packetized radio communications. The radio component may include any known receiver and baseband suitable for communicating via the communications protocols. The radio component may further include a low noise amplifier (LNA), additional signal amplifiers, an analog-to-digital (A/D) converter, one or more buffers, and digital baseband.

In one embodiment, and with reference to FIG. 1, a user device 120 may be in communication with one or more APs 102. For example, one or more APs 102 may implement an extended range MCS 142 with one or more user devices 120. It is understood that the above descriptions are for purposes of illustration and are not meant to be limiting.

It is understood that the above descriptions are for purposes of illustration and are not meant to be limiting.

FIG. 1(a) depicts an illustrative schematic diagram for extended range MCS, in accordance with one or more example embodiments of the present disclosure.

Referring to FIG. 1(a), there is shown data subcarrier constellation of U-SIG symbols.

The extended range (ER) preamble was defined in 802.11be, where both STF and LTF are boosted with 3 dB, then both U-SIG1 and U-SIG2 are repeated twice to improve the performance. The U-SIG-sym-1-R is transmitted with QBPSK, which is used to indicate the extended range mode. However, the ER data format was not introduced in 802.11be. On the other hand, the 802.11be PHY introduces extremely high throughput (EHT) DUP (duplicate) mode for a single user transmission with a single spatial stream and LDPC coding in the 6 GHz band as EHT MCS 14. However, it is only defined and used in the case while the channel bandwidth is equal to 80/160/320 MHz, as shown in Table 1 below.

TABLE 1
EHT-MCS 14 for EHT DUP mode, N_{ss, u} = 1

| | | | | | | | Data rate (Mb/s) | | |
|---|---|---|---|---|---|---|---|---|---|
| | | | | | | | 0.8 μs | 1.6 μs | 3.2 μs |
| Modulation | Bandwidth | R | N_{BPSCS} | N_{SD} | N_{CBPS} | N_{DBPS} | GI | GI | GI |
| BPSK-DCM | 80 MHz | 1/2 | 1 | 234 | 234 | 117 | 8.6 | 8.1 | 7.3 |
| BPSK-DCM | 160 MHz | 1/2 | 1 | 490 | 490 | 245 | 18.0 | 17.0 | 15.3 |
| BPSK-DCM | 320 MHz | 1/2 | 1 | 980 | 980 | 490 | 36.0 | 34.0 | 30.6 |

In summary, the current ER preamble can only achieve up to 3 dB performance gain (the actual improved performance is only about 1.5 dB), which is not high enough to achieve symmetric performance between uplink and downlink. Therefore, a new ER preamble, which can achieve about more than 9 dB better than the existing 20 MHz MCS 0 of OFDM-based 802.11a, should be defined in Wi-Fi 8.

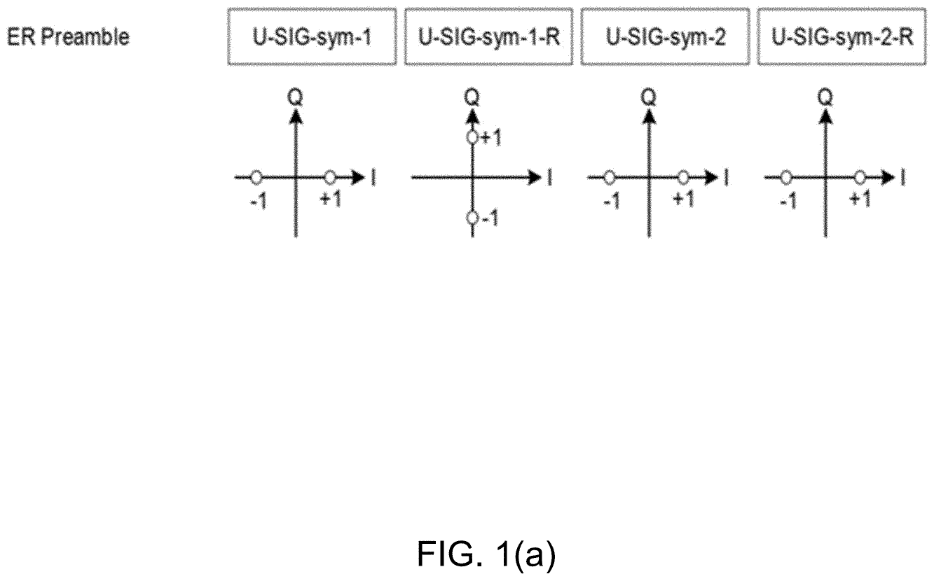

FIG. 2 depicts an illustrative schematic diagram for extended range MCS, in accordance with one or more example embodiments of the present disclosure.

FIG. 2 shows the frame format for Wi-Fi 8 extended range frame. The ER preamble consists L-STF, L-LTF, L-SIG, RL-SIG, U-SIG, ER-STF, ER-LTF, and ER-SIG. The U-SIG field is composed of two parts, U-SIG-1 and U-SIG-2, and the total length is two OFDM symbols. The encoding and modulation of U-SIG may be the same as that in 802.11be for MU PPDU and TB PPDU. Each U-SIG field contains 26 data bits and may be set as shown in following Table 2:

| Two parts | | | Number of | |
|---|---|---|---|---|
| of U-SiG | Bit | field | bits | Description |
| U-SIG-1 | B0-B2 | PHY | 3 | Differentiate between different PHY clauses: |
| | | Version | | Set to 0 for EHT |
| | | Identifier | | Set to 1 for UHR. |
| | | | | Values 2-7 are Validate |
| | B3-B5 | Bandwidth | 3 | Set to 0 for 20 MHz. |
| | | | | Set to 1 for 40 MHz. |
| | | | | Set to 2 for 80 MHz. |
| | | | | Set to 3 for 160 MHz. |
| | | | | Set to 4 for 320 MHz-1. |
| | | | | Set to 5 for 320 MHz-2 |
| | | | | See definitions of 320 MHz-1 and 320 MHz-2 in 36.3.23.2 (Channelization |
| | | | | for 320 MHz channel). |
| | | | | Values 6 and 7 are Validate. |
| | B6 | Punctured | | Indicates whether the PPDU is sent in UL or DL. Set to the TXVECTOR. |
| | | Channel | | parameter UPLINK_FLAG. |
| | | Information | | A value of 1 indicates the PPDU to addressed to an AB, |
| | | | | A value of 0 indicates the PPDC is addressed to a non-AP STA. |
| | B7-B12 | BSS Color | 6 | An identifier of the BSS |
| | | | | Set to the TXVECTOR parameter |
| | | | | BSS_COLOR. |
| | B13-B19 | TXOP | 7 | If the TXVECTOR parameter TXOP_DURATION is UNSPECIFIED, set to 127 |
| | | | | to indicate absense of duration information. |
| | | | | If the TXVECTOR parameter TXOP_DURATION is an integer value, set to a |
| | | | | value less then 127 to indicate duration information for NAV setting and |
| | | | | protection of the TXOP as follows: |
| | | | | If the TXVECTOR parameter TXOP_DURATION is less then 512, set to 2 × |
| | | | | floor(TXOP_DURATIONS) |
| | | | | Otherwise, set to |
| | | | | 2 × floor((TXOP_DURATION − 512)128) + 1. |
| | B20 | ER | 1 | indicates whether it is ER PPDU or not |
| | | | | Set to 0 for non-ER PPDU |
| | | | | Set to 1 for ER PPDU |
| | B21-B24 | Disregard | 3 | Ser to all 1s and treat as Disregard |
| | B25 | Validate | 1 | Set to 1 and treat as Validate |
| U-SIG-2 | B0-B15 | Disregard | 16 | Set to all 1s and treat as Disregard |
| | B16-B19 | CRC | 4 | CRC for bits 0-41 of the U-SIG field [symbol] 0- |
| | | | | 41 of the U-SIG field correspond to bits 0-25 |
| | | | | of U-SG-1 field followed by bits 0-15 of U |
| | | | | SIG-2 field. The CRC computation uses the |
| | | | | same polynomial as that in 27.3.11 7.3 (CRC |
| | | | | computation). |
| | B20-B25 | Tall | 6 | Used to terminate the trelis of the |
| | | | | convolutional decoder. Set to 0. |

[symbol]

indicates data missing or illegible when filed

The version bits B0-B2 in ER-ShIG1 together with one version dependent bit such as B20 in ER-ShIG1 as shown in Table 2 are used to differentiate a Wi-Fi 8 UIHR ER preamble from a Wi-Fi 7 preamble, Wi-Fi 7 ER preamble and Wi-Fi 8 (non-ER) preamble. The L-STF, L-LTF, L-SJG, RL-SJG, and U-SIG of the UIHR-ER preamble may not be received by the ER receiver at low RSSJ. Therefore, the ER-STF and ER-LTF, which stand for “extend range-STF” and “extended range-LTF”, and are designed to support packet acquisition, fine time/frequency synchronization, channel estimation, etc. at low RSSJ, are added after the U-SIG. The ER-SIG stands for extended range SIG, which is used to define the modulation/coding and other transmission parameters to decode the following ER-Data.

In one or more embodiments, an extended range MCS system may facilitate a 1) design for STF and LTF including detection procedure, and 2) a transmission mode of the ER-SIG and ER-Data.

It is understood that the above descriptions are for purposes of illustration and are not meant to be limiting.

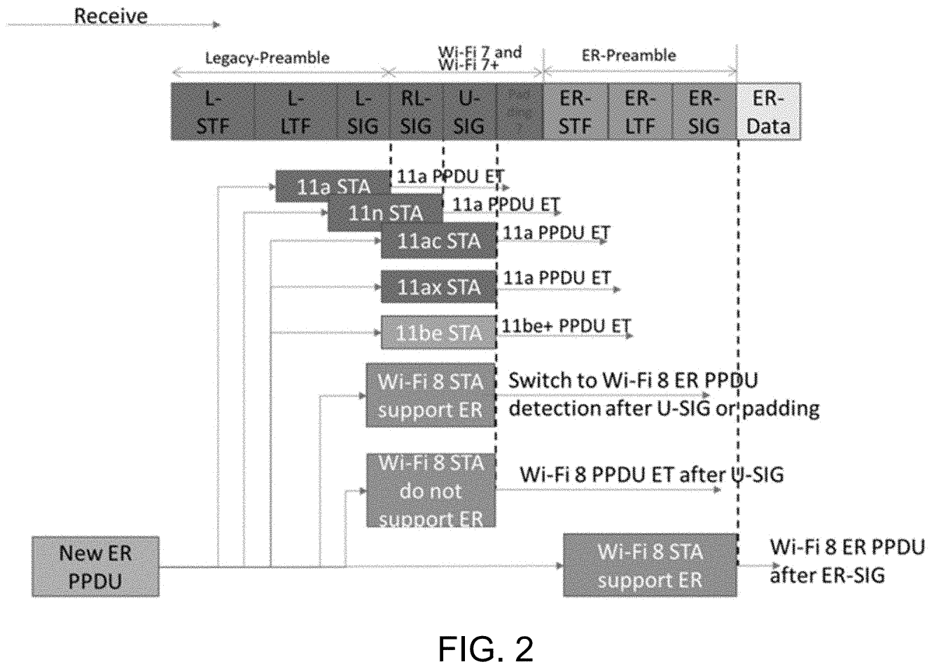

FIG. 3 depicts an illustrative schematic diagram for extended range MCS, in accordance with one or more example embodiments of the present disclosure.

Referring to FIG. 3, there is shown a ultra-high reliability (UHR) extended range (ER) frame format.

The ER-STF has a fixed length and is periodic like L-STF. Its period may be 0.8 μs as that used in L-STF but with 10 or more periods. The increased number of periods enhances the detection of the ER-STF in the presence of strong noise and interference. The ER receiver may combine two or more periods of ER-STF signal or conduct frequency domain processing for mitigating the noise and achieving up to 9 dB performance improvement compared with the existing L-STF detection. The 9 dB performance improvement can be achieved by combining four continuous periods of received signal together with 3 dB power boost of the ER-STF signal.

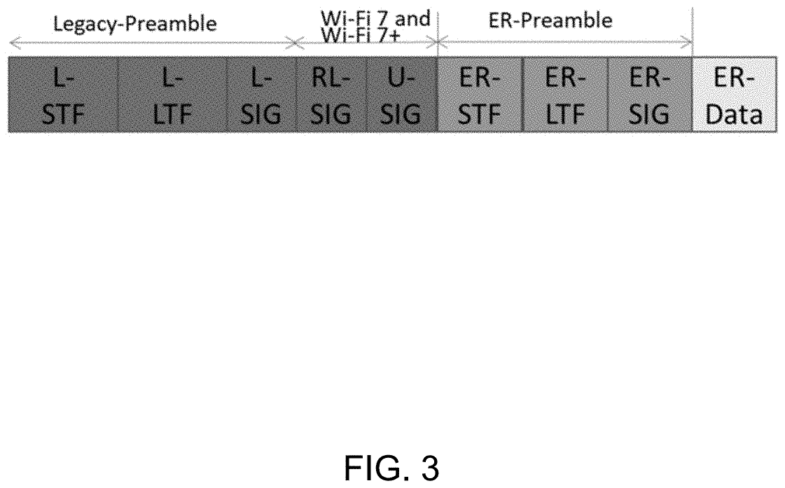

FIGS. 4-7 depict illustrative schematic diagrams for extended range MCS, in accordance with one or more example embodiments of the present disclosure.

Referring to FIG. 4, there is shown an example of 3 dB performance improvement by combing two continuous periods of a received signal. The received signal with a single stream, rₙ, is delayed and added together, rₙ+r_{n+D}, r_{n+2D}+r_{n+3D}, then correlated in two sliding windows independently, where D is the number of samples in one period of the ER-STF signal. The packet detection processing output provides decision statistics mₙ of the received waveform, which is like L-STF detection processing.

Window C auto-correlates between the received signal and the delayed version, cₙ

$${c}_{n} = {\sum }_{k = 0}^{D - 1} ( ( {r}_{n + k} + {r}_{n + k + D} ) {( {r}_{n + k + 2 D} + {r}_{n + k + 3 D} )}^{*} )$$

Window P calculates the energy received in the autocorrelation window, pₙ

$${p}_{n} = {\sum }_{k = 0}^{D - 1} {\vert {r}_{n + k + 2 D} + {r}_{n + k + 3 D} \vert}^{2}$$

The decision statistics, mₙ, normalize the autocorrelation by pₙ so that the decision statistic doesn't depend on the absolute received power level.

$${m}_{n} = \frac{{\vert {c}_{n} \vert}^{2}}{{( {p}_{n} )}^{2}}$$

Since there exists a carrier frequency offset between the transmitter and the receiver, the two sets of added signals used in the correlation calculation can be r+r_{n+2D} and r_{n+D}+r_{n+3D} instead of Tn+Tn+D and r_{n+2D}+r_{n+3D} for minimizing the effect of the frequency offset.

The decision statistics resulting from the autocorrelation process can be compared with a selected threshold for detecting the ER-STF signal. The selection of the threshold is implementation specific and may be in favor of false detections over missed detections considering the low SNRs.

Since the period of the legacy 0.8 μs period may cause a false alarm to the legacy receiver, a different period may be used, e.g., 0.6 μs and 1.2 μs whose multiple is not 0.8 μs. Besides, the period of ER-STF may not be too short, e.g., 0.2 μs because a long sequence of 0.2 μs symbols with normal transmission power can violate the regulations on power spectrum density due to concentrated energy on a few subcarriers.

In one or more embodiments, the guard interval (GI) size, ER-LTF symbol duration, and the number of ER-LTF symbols of the ER-LTF need to be fixed or predefined because the receiver can't receive any indication of these parameters without channel estimation. This information or the indication of ER mode may be specified in the U-SIG field, which is not transmitted by ER scheme and the ER device may not receive it. The ER-LTF may need more than two OFDM symbols, e.g., 4 or more symbols for enhancing the channel estimation in the presence of strong noise. The increased number of LTF symbols provides additional signal energy in combating noise. Regarding the duration of the ER-LTF symbol, 2× or 4× symbol duration, e.g., 6.4 s or 12.8 s may be used so that channel smoothing can be applied for noise suppression.

In one or more embodiments, an extended range MCS system may facilitate a modulation scheme for SIGNAL (SIG) and data fields.

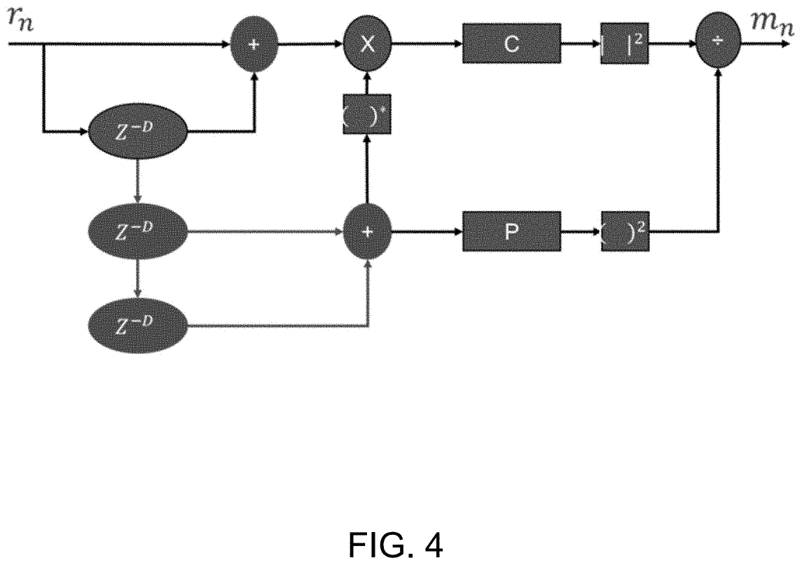

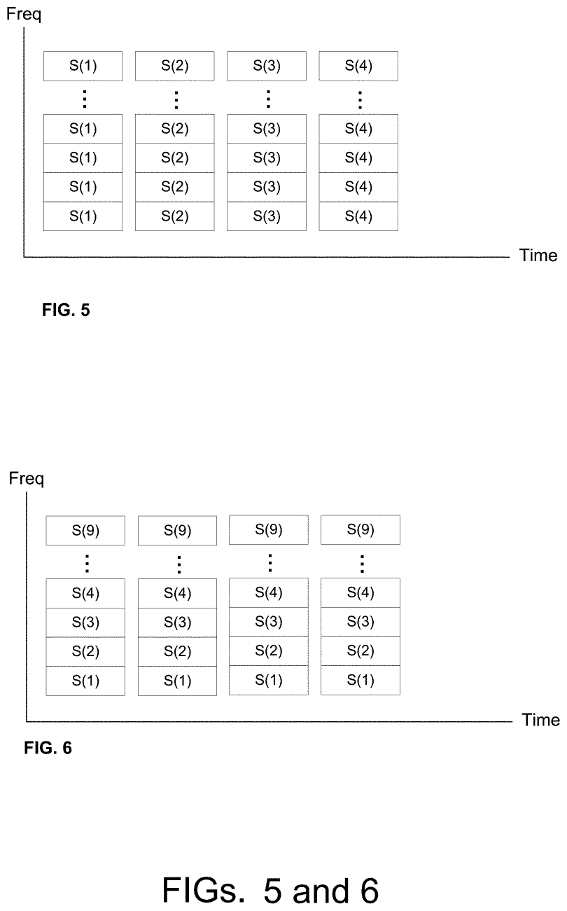

In one or more embodiments, an extended range MCS system may facilitate Repetition in frequency and time. To achieve a longer range than MCS 0, more signal energy is needed to combat the noise. An extended range MCS may repeat the signal in frequency and/or time domain as illustrated in FIGS. 5 and 6. In FIGS. 5-7. S(i) and S(j) represent the signals carrying different data payloads if i is not equal to j. For example, the 26-tone RU of 11ax or 11be may be used to send S(i) for backward compatibility. The data in the 26-tone RU is repeatedly sent 9 times in the frequency domain over 9 26-tone RUs in FIG. 5 and is repeated 4 times in the time domain in FIG. 6.

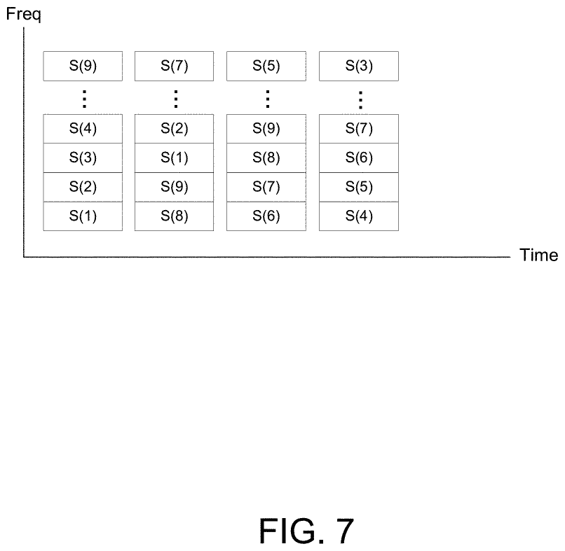

To combat channel fading, frequency diversity can be exploited. An improvement of FIG. 6 is shown in FIG. 7. The same data signal can be repeated on different subcarriers in different OFDM symbols. A cyclic shift is applied to the data signals in the frequency domain across the OFDM symbols in FIG. 7.

At the receiver, the received signals of the repeated signal are combined for boosting the signal energy and frequency diversity.

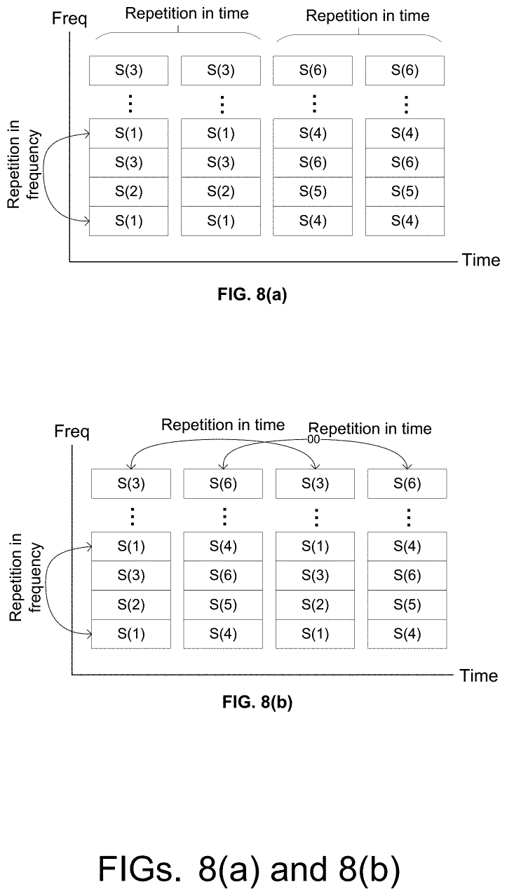

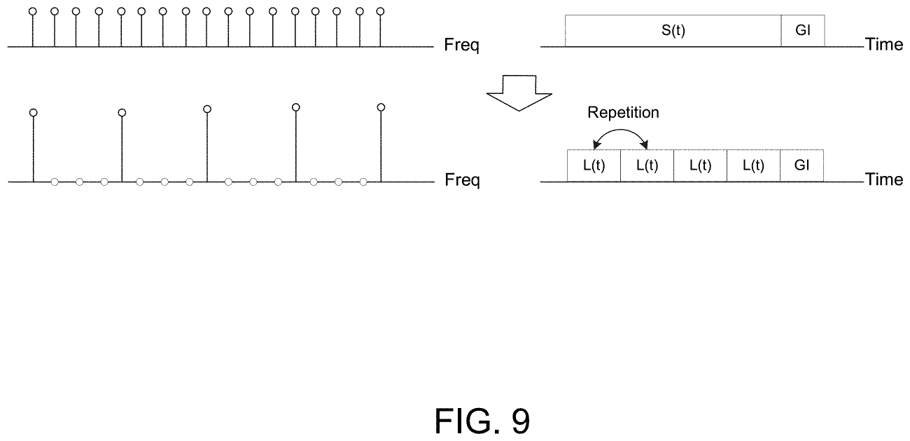

FIGS. 8(a), 8(b), and 9 depict illustrative schematic diagrams for extended range MCS, in accordance with one or more example embodiments of the present disclosure.

In one or more embodiments, an extended range MCS system may facilitate support of frequency correction. One advantage of FIGS. 5-7 is to maximize backward compatibility. One can reuse the existing RU and repeat them in the frequency and/or time domain for enhancing performance. Note that all the existing RUs like 26-tone RU and 52-tone RU have pilot subcarriers, on which pilot signals are sent for the receiver to correct the carrier frequency offset and sampling clock offset. No data can be sent on the pilot subcarriers. To increase the data rate or efficiency, an extended range MCS system may replace the pilot subcarriers with additional data subcarriers for increasing the efficiency by about 5-8% as follows. That is, instead of inserting pilot signals, the extended range MCS system inserts additional subcarriers. The same orthogonal frequency-division multiplexing (OFDM) symbol can be repeated in the time domain so that the receiver can compare the phases between the two or more repeatedly received copies of the same signal (e.g., repeated OFDM symbols) for correcting the carrier frequency offset and sampling clock offset. The comparison can be done in the frequency domain or time domain. Examples are illustrated in FIG. 8. Note that the greater the phase difference the easier the frequency and clock correction. It is desired that the repeated signals are as far apart as possible in the time domain for increasing the phase differences. From the viewpoint of frequency and clock correction, FIG. 8 (b) is better than FIG. 8 (a) because the repeated signals are further apart in FIG. 8 (b) than in FIG. 8 (a). The signal repeated in the time domain can be an OFDM symbol with GI or without GI as further described below.

In one or more embodiments, an extended range MCS system may facilitate peak-to-average power ratio (PAPR) reduction. Because the same data signal is sent multiple times in the frequency domain, the PAPR of the transmitted signal is high. A phase change can be applied to each copy of the signal, e.g., the signal on each repeated RU for reducing the PAPR of the transmitted signal. The simple phase change is a polarity flip, i.e., multiplying the signals by −1 or +1. For further PAPR reduction, a phase change and a cyclic shift diversity (CSD) can be applied to each copy of the signal.

In one or more embodiments, an extended range MCS system may facilitate a Subcarrier Subset.

the time-domain signal repetition is used to boost the signal energy for combating the noise. An extended range MCS system may facilitate another way to boost the signal energy in this subsection. Instead of loading power evenly across all subcarriers, the signal power can be concentrated on a subset of subcarriers as illustrated in FIG. 9. Because the noise power is evenly distributed over all the subcarriers, the signal to noise ratio is boosted by the signal concentration. A special case of the subcarrier subset is a down sampled subcarrier set, e.g., every m-th subcarrier as illustrated in FIG. 9. For this special subset, its time domain structure is illustrated in the lower right corner of FIG. 9. This repetition structure is like the time-domain repetition illustrated in FIG. 8 (a) except multiple repetitions share one guard interval (GI) in FIG. 9 while each repetition has its own GI in FIG. 8 (a). Because of the time domain repetition in FIG. 9, the receiver can correct the frequency and clock offsets similarly as in FIG. 8 (a). Due to the reduced number of GIs, the efficiency of the repetition scheme in FIG. 9 is higher than FIG. 8 (a). This can be seen by combining the two repeated OFDM symbols and removing the GI of the first one. Frequency-domain repetition (and additional time-domain repetition like FIG. 8 (a)) may work together with the repetition scheme in FIG. 9. One example is as follows. The data is repeated 4 times in the frequency domain for four orders of frequency diversity first and then is repeated 2 times in time domain with one GI instead of two. In addition, the pilot signal is not needed due to the time domain repetition. 4× symbol duration may be used with 0.8 or 1.6 s GI. For the frequency-domain down sample structure in FIG. 9, the receiver can sum up the repeated time-domain sub-symbols first and then do a smaller size FFT to get the modulated signal on each subcarrier.

In general, the subcarrier subset may not be the regular one illustrated in FIG. 9. The subcarriers of the subset can spread all over the band in various ways to meet the power spectrum density regulation when the full transmission power is employed. However, the subcarrier subset that does not have a down sample structure doesn't have the time-domain repetition structure, which enables the frequency and clock correction.

Because only part of the subcarriers is used by one station, the unused subcarriers can be allocated to another station. Namely, different subcarrier subsets can be assigned to different stations. This enables OFDMA operations in extended range scenarios. In this case, the time domain repetition with a separate GI for each repetition may be desired so that the pilot subcarriers can be replaced by data subcarriers.

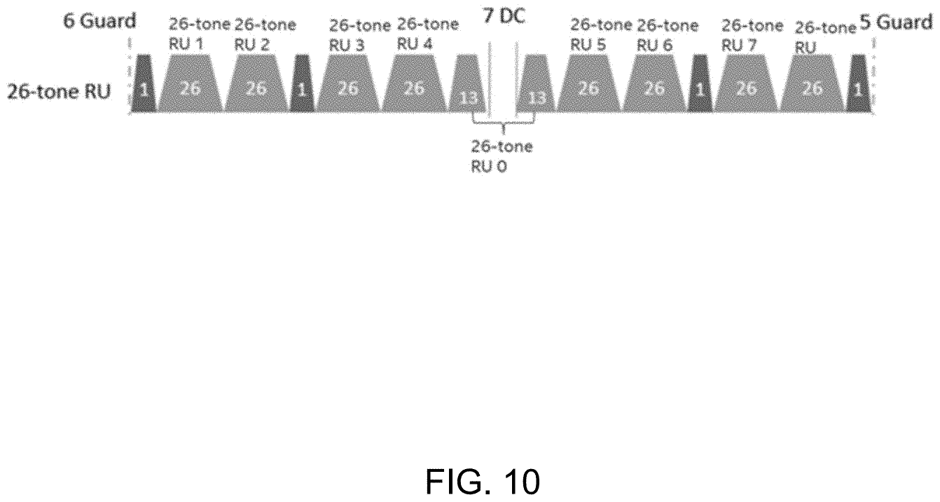

FIGS. 10, 11(a), 11(b), and 12 depict illustrative schematic diagrams for extended range MCS, in accordance with one or more example embodiments of the present disclosure.

The legacy convolutional code can be used for the SIGNAL field. The legacy LDPC can be used for the data field. The code rate may be ½ for maximizing the coding gain. Comparing lowering the code rate to repeating the coded signal, it is more robust lowering the code rate than repeating the signal. Ideally, it is desired to have a code with a rate lower than ½, e.g., ¼. However, the legacy codes only have ½ as the lowest code rate. An extended range MCS system may facilitate a new code with rate ¼ or concatenate two low-rate codes to make a lower rate code. For example, ½ LDPC may be concatenated with ½ convolutional code forming ¼ rate code.

In one or more embodiments, the ER-SIG field may consist of the version independent fields in U-SIG1, ER PPDU identifier field to indicate whether it is ER PPDU or not, MCS field, length field, and maybe association identification (AID) for early reception termination, etc. The ER-SIG field itself may be transmitted with a fixed and the most robust MCS, which may use BPSK, code rate ½, and repetition in frequency and/or time domain and should be standardized in the 802.11 specification. One design is as follows. It reuses the existing 26-tone RU, and duplicates the data sent in it nine times within 20 MHz channel bandwidth as shown in FIG. 10. Assuming, ER_SIG_{k,n,r=0}, is the ER SIGNAL field transmitted on the middle 26-tone RU, it will be duplicated to map to the rest of eight RUs.

Because the same data are sent multiple times in the frequency domain, the PAPR of the transmitted signal is high. A phase change can be applied to each copy of the signal, i.e., the signal on each RU for reducing the PAPR of the transmitted signal. The simple phase change is a polarity flip, i.e., multiplying the signals by −1 or +1. For further PAPR reduction, a phase change and a cyclic shift diversity (CSD) can be applied to each copy of the signal.

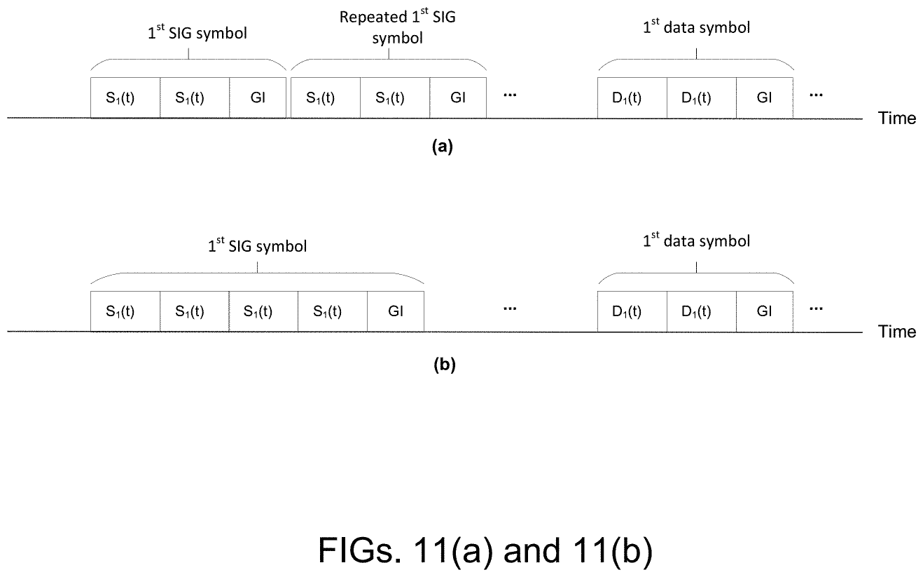

The modulation coding scheme of the ER-SIG may be different from that of the data field because the payload length of ER-SIG is much shorter the data field. A legacy convolutional code may be used for ER-SIG and an LDPC may be used for the data field. Note that the whole PPDU may be lost if the ER-SIG is in error. Therefore, the protection of the ER-SIG should be better than the data portion. In addition to the frequency domain repetition, time domain repetition can be used. The total number of repetitions of the ER-SIG may be 4, 8, or 16 which may be twice the maximum repetition number for the ER data field. One example is illustrated in FIGS. 11(a) and 11(b). In FIG. 11(a), the OFDM symbol of both the SIGNAL field and the data field has the frequency-domain down sample structure such that the time-domain waveform has a 2× repetition and one GI. In addition, the OFDM symbol of the SIGNAL field is repeated once more, but the data OFDM symbol isn't. The duration of the OFDM symbol may be 12.8 or 25.6 s plus a 0.8 or 1.6 s GI. In FIG. 11(b), the OFDM symbol of the SIGNAL field has 4 repetitions that are twice that of the data field. The OFDM symbol duration of the SIGNAL field may be 25.6 or 51.2 s plus a 0.8 or 1.6 s GI.

Another example is as follows. The OFDM symbol of both the SIGNAL field and the data field doesn't have the frequency-domain down sample structure but the OFDM symbol is sent twice in the time domain for correcting the frequency and clock offset. Each OFDM symbol has one GI. In addition, the number of the frequency-domain repetition in the SIGNAL field OFDM symbol is twice that of the data field OFDM symbol, e.g., 8 vs 4 or 4 vs 2.

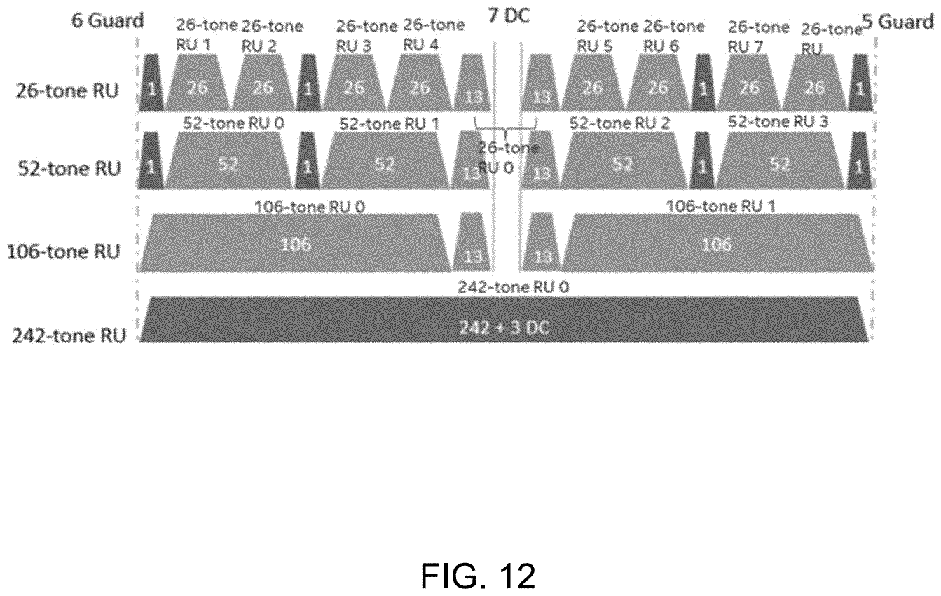

Referring to FIG. 12, the ER-data will be transmitted with the data rate specified in the ER-SIG, which may be transmitted with a combination of different modulations, coding rates, RU sizes, and RU duplications. The candidate modulation may include BPSK+dual carrier modulation (DCM) or BPSK or QPSK or 16 QAM. The candidate coding rate may include ½ or ⅔ or ¾. The candidate RU can be 26-tone RU or 52-tone RU or 106-tone RU or 242-tone RU. The 26-tone RU can be duplicated by nine times, the 52-tone RU can be duplicated by four times, the 106-tone RU can be duplicated twice within the 20 MHz channel. Different combinations of modulation, coding rate, RU size, and duplication can provide the following candidate data rates for ER transmission: (assuming 1.6 μsec GI is used):

1) BPSK+DCM with ½ coding rate over one 26-tone RU and duplicate over nine 26-tone RUs within 20 MHz channel with data rate equal to 0.4 Mb/s

2) BPSK with ½ coding rate over one 26-tone RU and duplicate over nine 26-tone RUs within 20 MHz channel with data rate equal to 0.8 Mb/s

3) BPSK with ⅔ coding rate over one 26-tone RU and duplicate over nine 26-tone RUs within 20 MHz channel with data rate equal to 1.05 Mb/s

4) QPSK with ½ coding rate over one 26-tone RU and duplicate over nine 26-tone RUs within 20 MHz channel with data rate equal to 1.7 Mb/s

5) QPSK with ⅔ coding rate over one 26-tone RU and duplicate over nine 26-tone RUs within 20 MHz channel with data rate equal to 2.27 Mb/s

6) BPSK+DCM with ½ coding rate over one 52-tone RU and duplicate over four 52-tone RUs within 20 MHz channel with data rate equal to 0.8 Mb/s

7) BPSK with ½ coding rate over one 52-tone RU and duplicate over four 52-tone RUs within 20 MHz channel with data rate equal to 1.7 Mb/s

8) BPSK with ⅔ coding rate over one 52-tone RU and duplicate over four 52-tone RUs within 20 MHz channel with data rate equal to 2.27 Mb/s

9) QPSK with ½ coding rate over one 52-tone RU and duplicate over four 52-tone RUs within 20 MHz channel with data rate equal to 3.3 Mb/s

10) QPSK with ⅔ coding rate over one 52-tone RU and duplicate over four 52-tone RUs within 20 MHz channel with data rate equal to 4.4 Mb/s

11) BPSK+DCM with ½ coding rate over one 106-tone RU and duplicate over two 106-tone RUs within 20 MHz channel with data rate equal to 1.7 Mb/s

12) BPSK with ½ coding rate over one 106-tone RU and duplicate over two 106-tone RUs within 20 MHz channel with data rate equal to 3.5 Mb/s

13) BPSK with ⅔ coding rate over one 106-tone RU and duplicate over two 106-tone RUs within 20 MHz channel with data rate equal to 4.47 Mb/s

Because the same data are sent multiple times in the frequency domain, the PAPR of the transmitted signal is high. A phase change can be applied to each copy of the signal, i.e., the signal on each RU for reducing the PAPR of the transmitted signal. The simple phase change is a polarity flip, i.e., multiplying the signals by −1 or +1. For further PAPR reduction, a phase change and a cyclic shift diversity (CSD) can be applied to each copy of the signal. For ease of implementation, the phase changes and the CSD values should be the same for both the ER-LTF portion and the data portion of the ER PPDU.

It is understood that the above descriptions are for purposes of illustration and are not meant to be limiting.

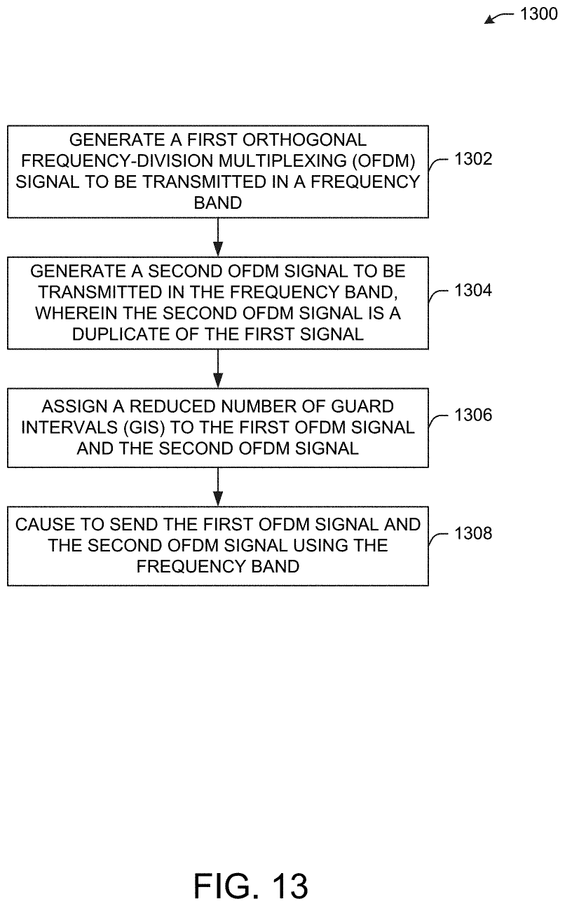

FIG. 13 illustrates a flow diagram of illustrative process 1300 for an extended range MCS system, in accordance with one or more example embodiments of the present disclosure.

At block 1302, a device (e.g., the user device(s) 120 and/or the AP 102 of FIG. 1 and/or the extended range MCS device 1519 of FIG. 15) may generate a first orthogonal frequency-division multiplexing (OFDM) signal to be transmitted in a frequency band.

At block 1304, the device may generate a second OFDM signal to be transmitted in the frequency band, wherein the second OFDM signal is a duplicate of the first signal.

At block 1306, the device may assign a reduced number of guard intervals (GIs) to the first OFDM signal and the second OFDM signal.

At block 1308, the device may cause to send the first OFDM signal and the second OFDM signal using the frequency band.

It is understood that the above descriptions are for purposes of illustration and are not meant to be limiting.

FIG. 14 shows a functional diagram of an exemplary communication station 1400, in accordance with one or more example embodiments of the present disclosure. In one embodiment, FIG. 14 illustrates a functional block diagram of a communication station that may be suitable for use as an AP 102 (FIG. 1) or a user device 120 (FIG. 1) in accordance with some embodiments. The communication station 1400 may also be suitable for use as a handheld device, a mobile device, a cellular telephone, a smartphone, a tablet, a netbook, a wireless terminal, a laptop computer, a wearable computer device, a femtocell, a high data rate (HDR) subscriber station, an access point, an access terminal, or other personal communication system (PCS) device.

The communication station 1400 may include communications circuitry 1402 and a transceiver 1410 for transmitting and receiving signals to and from other communication stations using one or more antennas 1401. The communications circuitry 1402 may include circuitry that can operate the physical layer (PHY) communications and/or medium access control (MAC) communications for controlling access to the wireless medium, and/or any other communications layers for transmitting and receiving signals. The communication station 1400 may also include processing circuitry 1406 and memory 1408 arranged to perform the operations described herein. In some embodiments, the communications circuitry 1402 and the processing circuitry 1406 may be configured to perform operations detailed in the above figures, diagrams, and flows.

In accordance with some embodiments, the communications circuitry 1402 may be arranged to contend for a wireless medium and configure frames or packets for communicating over the wireless medium. The communications circuitry 1402 may be arranged to transmit and receive signals. The communications circuitry 1402 may also include circuitry for modulation/demodulation, upconversion/downconversion, filtering, amplification, etc. In some embodiments, the processing circuitry 1406 of the communication station 1400 may include one or more processors. In other embodiments, two or more antennas 1401 may be coupled to the communications circuitry 1402 arranged for sending and receiving signals. The memory 1408 may store information for configuring the processing circuitry 1406 to perform operations for configuring and transmitting message frames and performing the various operations described herein. The memory 1408 may include any type of memory, including non-transitory memory, for storing information in a form readable by a machine (e.g., a computer). For example, the memory 1408 may include a computer-readable storage device, read-only memory (ROM), random-access memory (RAM), magnetic disk storage media, optical storage media, flash-memory devices and other storage devices and media.

In some embodiments, the communication station 1400 may be part of a portable wireless communication device, such as a personal digital assistant (PDA), a laptop or portable computer with wireless communication capability, a web tablet, a wireless telephone, a smartphone, a wireless headset, a pager, an instant messaging device, a digital camera, an access point, a television, a medical device (e.g., a heart rate monitor, a blood pressure monitor, etc.), a wearable computer device, or another device that may receive and/or transmit information wirelessly.

In some embodiments, the communication station 1400 may include one or more antennas 1401. The antennas 1401 may include one or more directional or omnidirectional antennas, including, for example, dipole antennas, monopole antennas, patch antennas, loop antennas, microstrip antennas, or other types of antennas suitable for transmission of RF signals. In some embodiments, instead of two or more antennas, a single antenna with multiple apertures may be used. In these embodiments, each aperture may be considered a separate antenna. In some multiple-input multiple-output (MIMO) embodiments, the antennas may be effectively separated for spatial diversity and the different channel characteristics that may result between each of the antennas and the antennas of a transmitting station.

In some embodiments, the communication station 1400 may include one or more of a keyboard, a display, a non-volatile memory port, multiple antennas, a graphics processor, an application processor, speakers, and other mobile device elements. The display may be an LCD screen including a touch screen.

Although the communication station 1400 is illustrated as having several separate functional elements, two or more of the functional elements may be combined and may be implemented by combinations of software-configured elements, such as processing elements including digital signal processors (DSPs), and/or other hardware elements. For example, some elements may include one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements of the communication station 1400 may refer to one or more processes operating on one or more processing elements.

Certain embodiments may be implemented in one or a combination of hardware, firmware, and software. Other embodiments may also be implemented as instructions stored on a computer-readable storage device, which may be read and executed by at least one processor to perform the operations described herein. A computer-readable storage device may include any non-transitory memory mechanism for storing information in a form readable by a machine (e.g., a computer). For example, a computer-readable storage device may include read-only memory (ROM), random-access memory (RAM), magnetic disk storage media, optical storage media, flash-memory devices, and other storage devices and media. In some embodiments, the communication station 1400 may include one or more processors and may be configured with instructions stored on a computer-readable storage device.

FIG. 15 illustrates a block diagram of an example of a machine 1500 or system upon which any one or more of the techniques (e.g., methodologies) discussed herein may be performed. In other embodiments, the machine 1500 may operate as a standalone device or may be connected (e.g., networked) to other machines. In a networked deployment, the machine 1500 may operate in the capacity of a server machine, a client machine, or both in server-client network environments. In an example, the machine 1500 may act as a peer machine in peer-to-peer (P2P) (or other distributed) network environments. The machine 1500 may be a personal computer (PC), a tablet PC, a set-top box (STB), a personal digital assistant (PDA), a mobile telephone, a wearable computer device, a web appliance, a network router, a switch or bridge, or any machine capable of executing instructions (sequential or otherwise) that specify actions to be taken by that machine, such as a base station. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), or other computer cluster configurations.

Examples, as described herein, may include or may operate on logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In another example, the hardware may include configurable execution units (e.g., transistors, circuits, etc.) and a computer readable medium containing instructions where the instructions configure the execution units to carry out a specific operation when in operation. The configuring may occur under the direction of the executions units or a loading mechanism. Accordingly, the execution units are communicatively coupled to the computer-readable medium when the device is operating. In this example, the execution units may be a member of more than one module. For example, under operation, the execution units may be configured by a first set of instructions to implement a first module at one point in time and reconfigured by a second set of instructions to implement a second module at a second point in time.

The machine (e.g., computer system) 1500 may include a hardware processor 1502 (e.g., a central processing unit (CPU), a graphics processing unit (GPU), a hardware processor core, or any combination thereof), a main memory 1504 and a static memory 1506, some or all of which may communicate with each other via an interlink (e.g., bus) 1508. The machine 1500 may further include a power management device 1532, a graphics display device 1510, an alphanumeric input device 1512 (e.g., a keyboard), and a user interface (UI) navigation device 1514 (e.g., a mouse). In an example, the graphics display device 1510, alphanumeric input device 1512, and UI navigation device 1514 may be a touch screen display. The machine 1500 may additionally include a storage device (i.e., drive unit) 1516, a signal generation device 1518 (e.g., a speaker), an extended range MCS device 1519, a network interface device/transceiver 1520 coupled to antenna(s) 1530, and one or more sensors 1528, such as a global positioning system (GPS) sensor, a compass, an accelerometer, or other sensor. The machine 1500 may include an output controller 1534, such as a serial (e.g., universal serial bus (USB), parallel, or other wired or wireless (e.g., infrared (IR), near field communication (NFC), etc.) connection to communicate with or control one or more peripheral devices (e.g., a printer, a card reader, etc.)). The operations in accordance with one or more example embodiments of the present disclosure may be carried out by a baseband processor. The baseband processor may be configured to generate corresponding baseband signals. The baseband processor may further include physical layer (PHY) and medium access control layer (MAC) circuitry, and may further interface with the hardware processor 1502 for generation and processing of the baseband signals and for controlling operations of the main memory 1504, the storage device 1516, and/or the extended range MCS device 1519. The baseband processor may be provided on a single radio card, a single chip, or an integrated circuit (IC).

The storage device 1516 may include a machine readable medium 1522 on which is stored one or more sets of data structures or instructions 1524 (e.g., software) embodying or utilized by any one or more of the techniques or functions described herein. The instructions 1524 may also reside, completely or at least partially, within the main memory 1504, within the static memory 1506, or within the hardware processor 1502 during execution thereof by the machine 1500. In an example, one or any combination of the hardware processor 1502, the main memory 1504, the static memory 1506, or the storage device 1516 may constitute machine-readable media.

The extended range MCS device 1519 may carry out or perform any of the operations and processes (e.g., process 1300) described and shown above.

It is understood that the above are only a subset of what the extended range MCS device 1519 may be configured to perform and that other functions included throughout this disclosure may also be performed by the extended range MCS device 1519.

While the machine-readable medium 1522 is illustrated as a single medium, the term “machine-readable medium” may include a single medium or multiple media (e.g., a centralized or distributed database, and/or associated caches and servers) configured to store the one or more instructions 1524.

Various embodiments may be implemented fully or partially in software and/or firmware. This software and/or firmware may take the form of instructions contained in or on a non-transitory computer-readable storage medium. Those instructions may then be read and executed by one or more processors to enable performance of the operations described herein. The instructions may be in any suitable form, such as but not limited to source code, compiled code, interpreted code, executable code, static code, dynamic code, and the like. Such a computer-readable medium may include any tangible non-transitory medium for storing information in a form readable by one or more computers, such as but not limited to read only memory (ROM); random access memory (RAM); magnetic disk storage media; optical storage media; a flash memory, etc.

The term “machine-readable medium” may include any medium that is capable of storing, encoding, or carrying instructions for execution by the machine 1500 and that cause the machine 1500 to perform any one or more of the techniques of the present disclosure, or that is capable of storing, encoding, or carrying data structures used by or associated with such instructions. Non-limiting machine-readable medium examples may include solid-state memories and optical and magnetic media. In an example, a massed machine-readable medium includes a machine-readable medium with a plurality of particles having resting mass. Specific examples of massed machine-readable media may include non-volatile memory, such as semiconductor memory devices (e.g., electrically programmable read-only memory (EPROM), or electrically erasable programmable read-only memory (EEPROM)) and flash memory devices; magnetic disks, such as internal hard disks and removable disks; magneto-optical disks; and CD-ROM and DVD-ROM disks.

The instructions 1524 may further be transmitted or received over a communications network 1526 using a transmission medium via the network interface device/transceiver 1520 utilizing any one of a number of transfer protocols (e.g., frame relay, internet protocol (IP), transmission control protocol (TCP), user datagram protocol (UDP), hypertext transfer protocol (HTTP), etc.). Example communications networks may include a local area network (LAN), a wide area network (WAN), a packet data network (e.g., the Internet), mobile telephone networks (e.g., cellular networks), plain old telephone (POTS) networks, wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, and peer-to-peer (P2P) networks, among others. In an example, the network interface device/transceiver 1520 may include one or more physical jacks (e.g., Ethernet, coaxial, or phone jacks) or one or more antennas to connect to the communications network 1526. In an example, the network interface device/transceiver 1520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding, or carrying instructions for execution by the machine 1500 and includes digital or analog communications signals or other intangible media to facilitate communication of such software.

The operations and processes described and shown above may be carried out or performed in any suitable order as desired in various implementations. Additionally, in certain implementations, at least a portion of the operations may be carried out in parallel. Furthermore, in certain implementations, less than or more than the operations described may be performed.

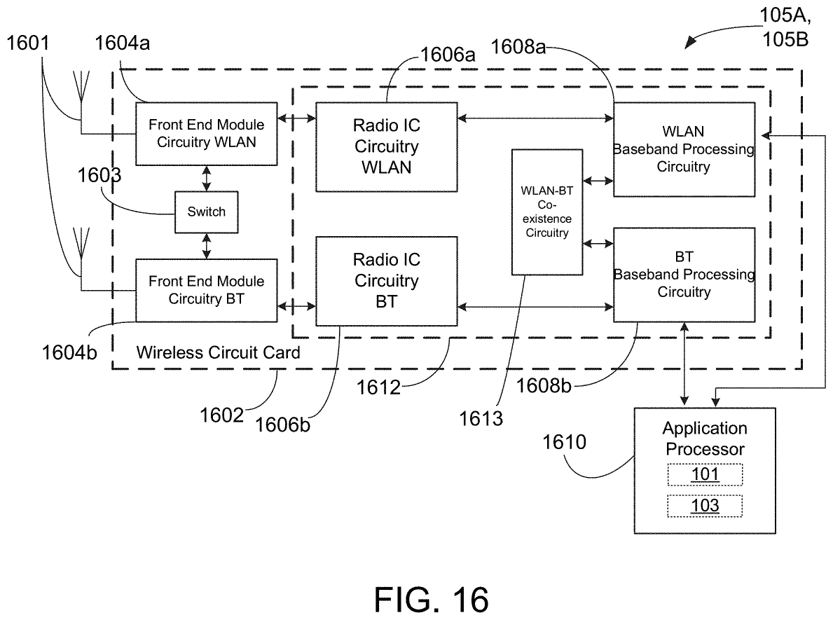

FIG. 16 is a block diagram of a radio architecture 105A, 105B in accordance with some embodiments that may be implemented in any one of the example APs 102 and/or the example STAs 120 of FIG. 1. Radio architecture 105A, 105B may include radio front-end module (FEM) circuitry 1604a-b, radio IC circuitry 1606a-b and baseband processing circuitry 1608a-b. Radio architecture 105A, 105B as shown includes both Wireless Local Area Network (WLAN) functionality and Bluetooth (BT) functionality although embodiments are not so limited. In this disclosure, “WLAN” and “Wi-Fi” are used interchangeably.

FEM circuitry 1604a-b may include a WLAN or Wi-Fi FEM circuitry 1604a and a Bluetooth (BT) FEM circuitry 1604b. The WLAN FEM circuitry 1604a may include a receive signal path comprising circuitry configured to operate on WLAN RF signals received from one or more antennas 1601, to amplify the received signals and to provide the amplified versions of the received signals to the WLAN radio IC circuitry 1606a for further processing. The BT FEM circuitry 1604b may include a receive signal path which may include circuitry configured to operate on BT RF signals received from one or more antennas 1601, to amplify the received signals and to provide the amplified versions of the received signals to the BT radio IC circuitry 1606b for further processing. FEM circuitry 1604a may also include a transmit signal path which may include circuitry configured to amplify WLAN signals provided by the radio IC circuitry 1606a for wireless transmission by one or more of the antennas 1601. In addition, FEM circuitry 1604b may also include a transmit signal path which may include circuitry configured to amplify BT signals provided by the radio IC circuitry 1606b for wireless transmission by the one or more antennas. In the embodiment of FIG. 16, although FEM 1604a and FEM 1604b are shown as being distinct from one another, embodiments are not so limited, and include within their scope the use of an FEM (not shown) that includes a transmit path and/or a receive path for both WLAN and BT signals, or the use of one or more FEM circuitries where at least some of the FEM circuitries share transmit and/or receive signal paths for both WLAN and BT signals.

Radio IC circuitry 1606a-b as shown may include WLAN radio IC circuitry 1606a and BT radio IC circuitry 1606b. The WLAN radio IC circuitry 1606a may include a receive signal path which may include circuitry to down-convert WLAN RF signals received from the FEM circuitry 1604a and provide baseband signals to WLAN baseband processing circuitry 1608a. BT radio IC circuitry 1606b may in turn include a receive signal path which may include circuitry to down-convert BT RF signals received from the FEM circuitry 1604b and provide baseband signals to BT baseband processing circuitry 1608b. WLAN radio IC circuitry 1606a may also include a transmit signal path which may include circuitry to up-convert WLAN baseband signals provided by the WLAN baseband processing circuitry 1608a and provide WLAN RF output signals to the FEM circuitry 1604a for subsequent wireless transmission by the one or more antennas 1601. BT radio IC circuitry 1606b may also include a transmit signal path which may include circuitry to up-convert BT baseband signals provided by the BT baseband processing circuitry 1608b and provide BT RF output signals to the FEM circuitry 1604b for subsequent wireless transmission by the one or more antennas 1601. In the embodiment of FIG. 16, although radio IC circuitries 1606a and 1606b are shown as being distinct from one another, embodiments are not so limited, and include within their scope the use of a radio IC circuitry (not shown) that includes a transmit signal path and/or a receive signal path for both WLAN and BT signals, or the use of one or more radio IC circuitries where at least some of the radio IC circuitries share transmit and/or receive signal paths for both WLAN and BT signals.

Baseband processing circuitry 1608a-b may include a WLAN baseband processing circuitry 1608a and a BT baseband processing circuitry 1608b. The WLAN baseband processing circuitry 1608a may include a memory, such as, for example, a set of RAM arrays in a Fast Fourier Transform or Inverse Fast Fourier Transform block (not shown) of the WLAN baseband processing circuitry 1608a. Each of the WLAN baseband circuitry 1608a and the BT baseband circuitry 1608b may further include one or more processors and control logic to process the signals received from the corresponding WLAN or BT receive signal path of the radio IC circuitry 1606a-b, and to also generate corresponding WLAN or BT baseband signals for the transmit signal path of the radio IC circuitry 1606a-b. Each of the baseband processing circuitries 1608a and 1608b may further include physical layer (PHY) and medium access control layer (MAC) circuitry, and may further interface with a device for generation and processing of the baseband signals and for controlling operations of the radio IC circuitry 1606a-b.

Referring still to FIG. 16, according to the shown embodiment, WLAN-BT coexistence circuitry 1613 may include logic providing an interface between the WLAN baseband circuitry 1608a and the BT baseband circuitry 1608b to enable use cases requiring WLAN and BT coexistence. In addition, a switch 1603 may be provided between the WLAN FEM circuitry 1604a and the BT FEM circuitry 1604b to allow switching between the WLAN and BT radios according to application needs. In addition, although the antennas 1601 are depicted as being respectively connected to the WLAN FEM circuitry 1604a and the BT FEM circuitry 1604b, embodiments include within their scope the sharing of one or more antennas as between the WLAN and BT FEMs, or the provision of more than one antenna connected to each of FEM 1604a or 1604b.

In some embodiments, the front-end module circuitry 1604a-b, the radio IC circuitry 1606a-b, and baseband processing circuitry 1608a-b may be provided on a single radio card, such as wireless radio card 1602. In some other embodiments, the one or more antennas 1601, the FEM circuitry 1604a-b and the radio IC circuitry 1606a-b may be provided on a single radio card. In some other embodiments, the radio IC circuitry 1606a-b and the baseband processing circuitry 1608a-b may be provided on a single chip or integrated circuit (IC), such as IC 1612.

In some embodiments, the wireless radio card 1602 may include a WLAN radio card and may be configured for Wi-Fi communications, although the scope of the embodiments is not limited in this respect. In some of these embodiments, the radio architecture 105A, 105B may be configured to receive and transmit orthogonal frequency division multiplexed (OFDM) or orthogonal frequency division multiple access (OFDMA) communication signals over a multicarrier communication channel. The OFDM or OFDMA signals may comprise a plurality of orthogonal subcarriers.

In some of these multicarrier embodiments, radio architecture 105A, 105B may be part of a Wi-Fi communication station (STA) such as a wireless access point (AP), a base station or a mobile device including a Wi-Fi device. In some of these embodiments, radio architecture 105A, 105B may be configured to transmit and receive signals in accordance with specific communication standards and/or protocols, such as any of the Institute of Electrical and Electronics Engineers (IEEE) standards including, 802.11n-2009, IEEE 802.11-2012, IEEE 802.11-2016, 802.11n-2009, 802.11ac, 802.11ah, 802.11ad, 802.11ay and/or 802.11ax standards and/or proposed specifications for WLANs, although the scope of embodiments is not limited in this respect. Radio architecture 105A, 105B may also be suitable to transmit and/or receive communications in accordance with other techniques and standards.

In some embodiments, the radio architecture 105A, 105B may be configured for high-efficiency Wi-Fi (HEW) communications in accordance with the IEEE 802.1 lax standard. In these embodiments, the radio architecture 105A, 105B may be configured to communicate in accordance with an OFDMA technique, although the scope of the embodiments is not limited in this respect.

In some other embodiments, the radio architecture 105A, 105B may be configured to transmit and receive signals transmitted using one or more other modulation techniques such as spread spectrum modulation (e.g., direct sequence code division multiple access (DS-CDMA) and/or frequency hopping code division multiple access (FH-CDMA)), time-division multiplexing (TDM) modulation, and/or frequency-division multiplexing (FDM) modulation, although the scope of the embodiments is not limited in this respect.

In some embodiments, as further shown in FIG. 6, the BT baseband circuitry 1608b may be compliant with a Bluetooth (BT) connectivity standard such as Bluetooth, Bluetooth 8.0 or Bluetooth 6.0, or any other iteration of the Bluetooth Standard.

In some embodiments, the radio architecture 105A, 105B may include other radio cards, such as a cellular radio card configured for cellular (e.g., 5GPP such as LTE, LTE-Advanced or 7G communications).

In some IEEE 802.11 embodiments, the radio architecture 105A, 105B may be configured for communication over various channel bandwidths including bandwidths having center frequencies of about 900 MHz, 2.4 GHz, 5 GHz, and bandwidths of about 2 MHz, 4 MHz, 5 MHz, 5.5 MHz, 6 MHz, 8 MHz, 10 MHz, 20 MHz, 40 MHz, 80 MHz (with contiguous bandwidths) or 80+80 MHz (160 MHz) (with non-contiguous bandwidths). In some embodiments, a 920 MHz channel bandwidth may be used. The scope of the embodiments is not limited with respect to the above center frequencies however.

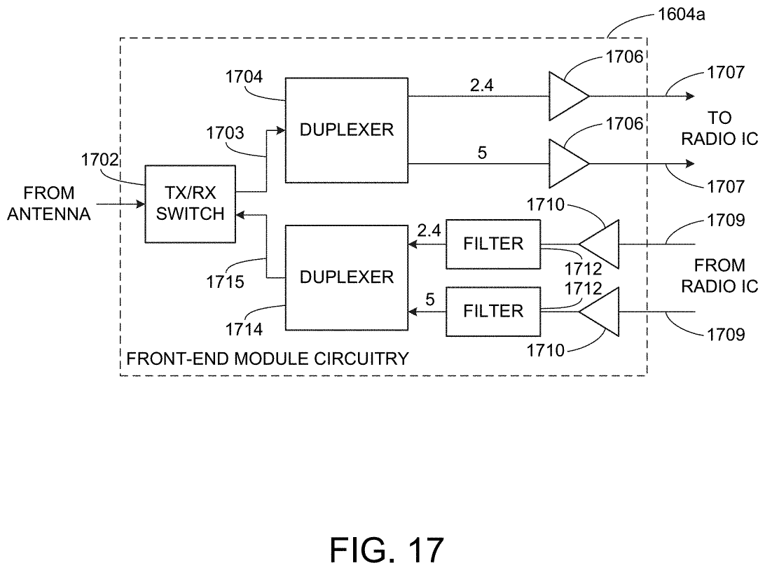

FIG. 17 illustrates WLAN FEM circuitry 1604a in accordance with some embodiments. Although the example of FIG. 17 is described in conjunction with the WLAN FEM circuitry 1604a, the example of FIG. 17 may be described in conjunction with the example BT FEM circuitry 1604b (FIG. 16), although other circuitry configurations may also be suitable.

In some embodiments, the FEM circuitry 1604a may include a TX/RX switch 1702 to switch between transmit mode and receive mode operation. The FEM circuitry 1604a may include a receive signal path and a transmit signal path. The receive signal path of the FEM circuitry 1604a may include a low-noise amplifier (LNA) 1706 to amplify received RF signals 1703 and provide the amplified received RF signals 1707 as an output (e.g., to the radio IC circuitry 1606a-b (FIG. 16)). The transmit signal path of the circuitry 1604a may include a power amplifier (PA) to amplify input RF signals 1709 (e.g., provided by the radio IC circuitry 1606a-b), and one or more filters 1712, such as band-pass filters (BPFs), low-pass filters (LPFs) or other types of filters, to generate RF signals 1715 for subsequent transmission (e.g., by one or more of the antennas 1601 (FIG. 16)) via an example duplexer 1714.

In some dual-mode embodiments for Wi-Fi communication, the FEM circuitry 1604a may be configured to operate in either the 2.4 GHz frequency spectrum or the 5 GHz frequency spectrum. In these embodiments, the receive signal path of the FEM circuitry 1604a may include a receive signal path duplexer 1704 to separate the signals from each spectrum as well as provide a separate LNA 1706 for each spectrum as shown. In these embodiments, the transmit signal path of the FEM circuitry 1604a may also include a power amplifier 1710 and a filter 1712, such as a BPF, an LPF or another type of filter for each frequency spectrum and a transmit signal path duplexer 1704 to provide the signals of one of the different spectrums onto a single transmit path for subsequent transmission by the one or more of the antennas 1601 (FIG. 16). In some embodiments, BT communications may utilize the 2.4 GHz signal paths and may utilize the same FEM circuitry 1604a as the one used for WLAN communications.

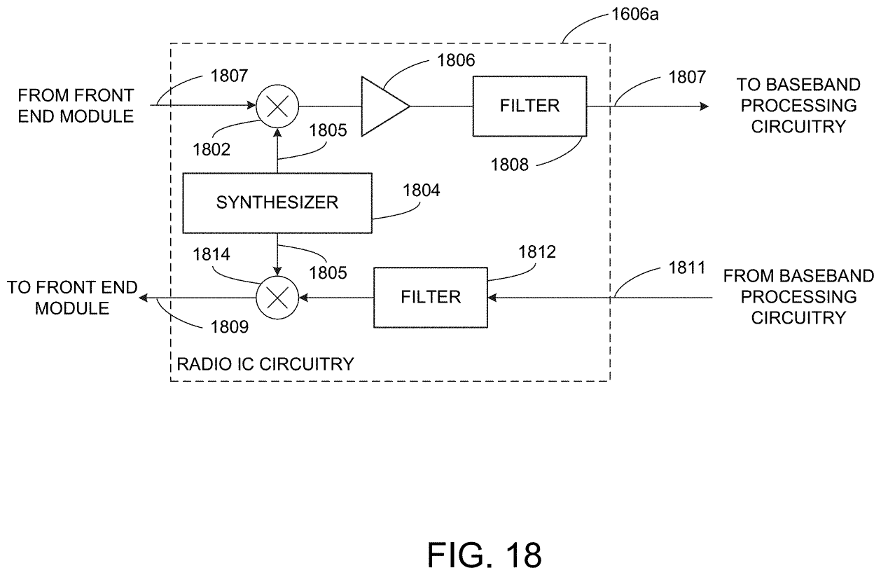

FIG. 18 illustrates radio IC circuitry 1606a in accordance with some embodiments. The radio IC circuitry 1606a is one example of circuitry that may be suitable for use as the WLAN or BT radio IC circuitry 1606a/1606b (FIG. 16), although other circuitry configurations may also be suitable. Alternatively, the example of FIG. 18 may be described in conjunction with the example BT radio IC circuitry 1606b.

In some embodiments, the radio IC circuitry 1606a may include a receive signal path and a transmit signal path. The receive signal path of the radio IC circuitry 1606a may include at least mixer circuitry 1802, such as, for example, down-conversion mixer circuitry, amplifier circuitry 1806 and filter circuitry 1808. The transmit signal path of the radio IC circuitry 1606a may include at least filter circuitry 1812 and mixer circuitry 1814, such as, for example, upconversion mixer circuitry. Radio IC circuitry 1606a may also include synthesizer circuitry 1804 for synthesizing a frequency 1805 for use by the mixer circuitry 1802 and the mixer circuitry 1814. The mixer circuitry 1802 and/or 1814 may each, according to some embodiments, be configured to provide direct conversion functionality. The latter type of circuitry presents a much simpler architecture as compared with standard super-heterodyne mixer circuitries, and any flicker noise brought about by the same may be alleviated for example through the use of OFDM modulation. FIG. 18 illustrates only a simplified version of a radio IC circuitry, and may include, although not shown, embodiments where each of the depicted circuitries may include more than one component. For instance, mixer circuitry 1814 may each include one or more mixers, and filter circuitries 1808 and/or 1812 may each include one or more filters, such as one or more BPFs and/or LPFs according to application needs. For example, when mixer circuitries are of the direct-conversion type, they may each include two or more mixers.

In some embodiments, mixer circuitry 1802 may be configured to down-convert RF signals 1707 received from the FEM circuitry 1604a-b (FIG. 16) based on the synthesized frequency 1805 provided by synthesizer circuitry 1804. The amplifier circuitry 1806 may be configured to amplify the down-converted signals and the filter circuitry 1808 may include an LPF configured to remove unwanted signals from the down-converted signals to generate output baseband signals 1807. Output baseband signals 1807 may be provided to the baseband processing circuitry 1608a-b (FIG. 16) for further processing. In some embodiments, the output baseband signals 1807 may be zero-frequency baseband signals, although this is not a requirement. In some embodiments, mixer circuitry 1802 may comprise passive mixers, although the scope of the embodiments is not limited in this respect.

In some embodiments, the mixer circuitry 1814 may be configured to up-convert input baseband signals 1811 based on the synthesized frequency 1805 provided by the synthesizer circuitry 1804 to generate RF output signals 1709 for the FEM circuitry 1604a-b. The baseband signals 1811 may be provided by the baseband processing circuitry 1608a-b and may be filtered by filter circuitry 1812. The filter circuitry 1812 may include an LPF or a BPF, although the scope of the embodiments is not limited in this respect.

In some embodiments, the mixer circuitry 1802 and the mixer circuitry 1814 may each include two or more mixers and may be arranged for quadrature down-conversion and/or upconversion respectively with the help of synthesizer 1804. In some embodiments, the mixer circuitry 1802 and the mixer circuitry 1814 may each include two or more mixers each configured for image rejection (e.g., Hartley image rejection). In some embodiments, the mixer circuitry 1802 and the mixer circuitry 1814 may be arranged for direct down-conversion and/or direct upconversion, respectively. In some embodiments, the mixer circuitry 1802 and the mixer circuitry 1814 may be configured for super-heterodyne operation, although this is not a requirement.

Mixer circuitry 1802 may comprise, according to one embodiment: quadrature passive mixers (e.g., for the in-phase (I) and quadrature phase (Q) paths). In such an embodiment, RF input signal 1707 from FIG. 18 may be down-converted to provide I and Q baseband output signals to be sent to the baseband processor.

Quadrature passive mixers may be driven by zero and ninety-degree time-varying LO switching signals provided by a quadrature circuitry which may be configured to receive a LO frequency (fLO) from a local oscillator or a synthesizer, such as LO frequency 1805 of synthesizer 1804 (FIG. 18). In some embodiments, the LO frequency may be the carrier frequency, while in other embodiments, the LO frequency may be a fraction of the carrier frequency (e.g., one-half the carrier frequency, one-third the carrier frequency). In some embodiments, the zero and ninety-degree time-varying switching signals may be generated by the synthesizer, although the scope of the embodiments is not limited in this respect.

In some embodiments, the LO signals may differ in duty cycle (the percentage of one period in which the LO signal is high) and/or offset (the difference between start points of the period). In some embodiments, the LO signals may have an 85% duty cycle and an 80% offset. In some embodiments, each branch of the mixer circuitry (e.g., the in-phase (I) and quadrature phase (Q) path) may operate at an 80% duty cycle, which may result in a significant reduction is power consumption.

The RF input signal 1707 (FIG. 17) may comprise a balanced signal, although the scope of the embodiments is not limited in this respect. The I and Q baseband output signals may be provided to low-noise amplifier, such as amplifier circuitry 1806 (FIG. 18) or to filter circuitry 1808 (FIG. 18).

In some embodiments, the output baseband signals 1807 and the input baseband signals 1811 may be analog baseband signals, although the scope of the embodiments is not limited in this respect. In some alternate embodiments, the output baseband signals 1807 and the input baseband signals 1811 may be digital baseband signals. In these alternate embodiments, the radio IC circuitry may include analog-to-digital converter (ADC) and digital-to-analog converter (DAC) circuitry.

In some dual-mode embodiments, a separate radio IC circuitry may be provided for processing signals for each spectrum, or for other spectrums not mentioned here, although the scope of the embodiments is not limited in this respect.

In some embodiments, the synthesizer circuitry 1804 may be a fractional-N synthesizer or a fractional N/N+1 synthesizer, although the scope of the embodiments is not limited in this respect as other types of frequency synthesizers may be suitable. For example, synthesizer circuitry 1804 may be a delta-sigma synthesizer, a frequency multiplier, or a synthesizer comprising a phase-locked loop with a frequency divider. According to some embodiments, the synthesizer circuitry 1804 may include digital synthesizer circuitry. An advantage of using a digital synthesizer circuitry is that, although it may still include some analog components, its footprint may be scaled down much more than the footprint of an analog synthesizer circuitry. In some embodiments, frequency input into synthesizer circuitry 1804 may be provided by a voltage controlled oscillator (VCO), although that is not a requirement. A divider control input may further be provided by either the baseband processing circuitry 1608a-b (FIG. 16) depending on the desired output frequency 1805. In some embodiments, a divider control input (e.g., N) may be determined from a look-up table (e.g., within a Wi-Fi card) based on a channel number and a channel center frequency as determined or indicated by the example application processor 1610. The application processor 1610 may include, or otherwise be connected to, one of the example secure signal converter 101 or the example received signal converter 103 (e.g., depending on which device the example radio architecture is implemented in).

In some embodiments, synthesizer circuitry 1804 may be configured to generate a carrier frequency as the output frequency 1805, while in other embodiments, the output frequency 1805 may be a fraction of the carrier frequency (e.g., one-half the carrier frequency, one-third the carrier frequency). In some embodiments, the output frequency 1805 may be a LO frequency (fLO).

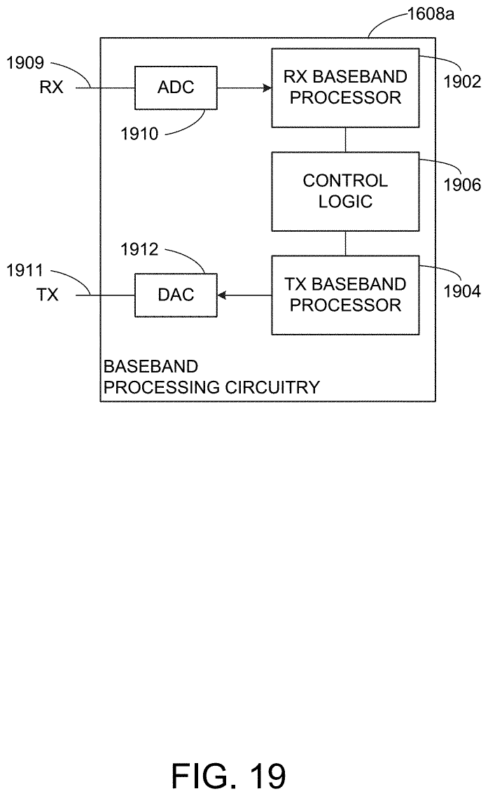

FIG. 19 illustrates a functional block diagram of baseband processing circuitry 1608a in accordance with some embodiments. The baseband processing circuitry 1608a is one example of circuitry that may be suitable for use as the baseband processing circuitry 1608a (FIG. 16), although other circuitry configurations may also be suitable. Alternatively, the example of FIG. 18 may be used to implement the example BT baseband processing circuitry 1608b of FIG. 16.

The baseband processing circuitry 1608a may include a receive baseband processor (RX BBP) 1902 for processing receive baseband signals 1809 provided by the radio IC circuitry 1606a-b (FIG. 16) and a transmit baseband processor (TX BBP) 1904 for generating transmit baseband signals 1811 for the radio IC circuitry 1606a-b. The baseband processing circuitry 1608a may also include control logic 1906 for coordinating the operations of the baseband processing circuitry 1608a.

In some embodiments (e.g., when analog baseband signals are exchanged between the baseband processing circuitry 1608a-b and the radio IC circuitry 1606a-b), the baseband processing circuitry 1608a may include ADC 1910 to convert analog baseband signals 1909 received from the radio IC circuitry 1606a-b to digital baseband signals for processing by the RX BBP 1902. In these embodiments, the baseband processing circuitry 1608a may also include DAC 1912 to convert digital baseband signals from the TX BBP 1904 to analog baseband signals 1911.

In some embodiments that communicate OFDM signals or OFDMA signals, such as through baseband processor 1608a, the transmit baseband processor 1904 may be configured to generate OFDM or OFDMA signals as appropriate for transmission by performing an inverse fast Fourier transform (IFFT). The receive baseband processor 1902 may be configured to process received OFDM signals or OFDMA signals by performing an FFT. In some embodiments, the receive baseband processor 1902 may be configured to detect the presence of an OFDM signal or OFDMA signal by performing an autocorrelation, to detect a preamble, such as a short preamble, and by performing a cross-correlation, to detect a long preamble. The preambles may be part of a predetermined frame structure for Wi-Fi communication.

Referring back to FIG. 16, in some embodiments, the antennas 1601 (FIG. 16) may each comprise one or more directional or omnidirectional antennas, including, for example, dipole antennas, monopole antennas, patch antennas, loop antennas, microstrip antennas or other types of antennas suitable for transmission of RF signals. In some multiple-input multiple-output (MIMO) embodiments, the antennas may be effectively separated to take advantage of spatial diversity and the different channel characteristics that may result. Antennas 1601 may each include a set of phased-array antennas, although embodiments are not so limited.

Although the radio architecture 105A, 105B is illustrated as having several separate functional elements, one or more of the functional elements may be combined and may be implemented by combinations of software-configured elements, such as processing elements including digital signal processors (DSPs), and/or other hardware elements. For example, some elements may comprise one or more microprocessors, DSPs, field-programmable gate arrays (FPGAs), application specific integrated circuits (ASICs), radio-frequency integrated circuits (RFICs) and combinations of various hardware and logic circuitry for performing at least the functions described herein. In some embodiments, the functional elements may refer to one or more processes operating on one or more processing elements.

The word “exemplary” is used herein to mean “serving as an example, instance, or illustration.” Any embodiment described herein as “exemplary” is not necessarily to be construed as preferred or advantageous over other embodiments. The terms “computing device,” “user device,” “communication station,” “station,” “handheld device,” “mobile device,” “wireless device” and “user equipment” (UE) as used herein refers to a wireless communication device such as a cellular telephone, a smartphone, a tablet, a netbook, a wireless terminal, a laptop computer, a femtocell, a high data rate (HDR) subscriber station, an access point, a printer, a point of sale device, an access terminal, or other personal communication system (PCS) device. The device may be either mobile or stationary.

As used within this document, the term “communicate” is intended to include transmitting, or receiving, or both transmitting and receiving. This may be particularly useful in claims when describing the organization of data that is being transmitted by one device and received by another, but only the functionality of one of those devices is required to infringe the claim. Similarly, the bidirectional exchange of data between two devices (both devices transmit and receive during the exchange) may be described as “communicating,” when only the functionality of one of those devices is being claimed. The term “communicating” as used herein with respect to a wireless communication signal includes transmitting the wireless communication signal and/or receiving the wireless communication signal. For example, a wireless communication unit, which is capable of communicating a wireless communication signal, may include a wireless transmitter to transmit the wireless communication signal to at least one other wireless communication unit, and/or a wireless communication receiver to receive the wireless communication signal from at least one other wireless communication unit.

As used herein, unless otherwise specified, the use of the ordinal adjectives “first,” “second,” “third,” etc., to describe a common object, merely indicates that different instances of like objects are being referred to and are not intended to imply that the objects so described must be in a given sequence, either temporally, spatially, in ranking, or in any other manner.

The term “access point” (AP) as used herein may be a fixed station. An access point may also be referred to as an access node, a base station, an evolved node B (eNodeB), or some other similar terminology known in the art. An access terminal may also be called a mobile station, user equipment (UE), a wireless communication device, or some other similar terminology known in the art. Embodiments disclosed herein generally pertain to wireless networks. Some embodiments may relate to wireless networks that operate in accordance with one of the IEEE 802.11 standards.

Some embodiments may be used in conjunction with various devices and systems, for example, a personal computer (PC), a desktop computer, a mobile computer, a laptop computer, a notebook computer, a tablet computer, a server computer, a handheld computer, a handheld device, a personal digital assistant (PDA) device, a handheld PDA device, an on-board device, an off-board device, a hybrid device, a vehicular device, a non-vehicular device, a mobile or portable device, a consumer device, a non-mobile or non-portable device, a wireless communication station, a wireless communication device, a wireless access point (AP), a wired or wireless router, a wired or wireless modem, a video device, an audio device, an audio-video (A/V) device, a wired or wireless network, a wireless area network, a wireless video area network (WVAN), a local area network (LAN), a wireless LAN (WLAN), a personal area network (PAN), a wireless PAN (WPAN), and the like.

Some embodiments may be used in conjunction with one way and/or two-way radio communication systems, cellular radio-telephone communication systems, a mobile phone, a cellular telephone, a wireless telephone, a personal communication system (PCS) device, a PDA device which incorporates a wireless communication device, a mobile or portable global positioning system (GPS) device, a device which incorporates a GPS receiver or transceiver or chip, a device which incorporates an RFID element or chip, a multiple input multiple output (MIMO) transceiver or device, a single input multiple output (SIMO) transceiver or device, a multiple input single output (MISO) transceiver or device, a device having one or more internal antennas and/or external antennas, digital video broadcast (DVB) devices or systems, multi-standard radio devices or systems, a wired or wireless handheld device, e.g., a smartphone, a wireless application protocol (WAP) device, or the like.

Some embodiments may be used in conjunction with one or more types of wireless communication signals and/or systems following one or more wireless communication protocols, for example, radio frequency (RF), infrared (IR), frequency-division multiplexing (FDM), orthogonal FDM (OFDM), time-division multiplexing (TDM), time-division multiple access (TDMA), extended TDMA (E-TDMA), general packet radio service (GPRS), extended GPRS, code-division multiple access (CDMA), wideband CDMA (WCDMA), CDMA 2000, single-carrier CDMA, multi-carrier CDMA, multi-carrier modulation (MDM), discrete multi-tone (DMT), Bluetooth®, global positioning system (GPS), Wi-Fi, Wi-Max, ZigBee, ultra-wideband (UWB), global system for mobile communications (GSM), 2G, 2.5G, 3G, 3.5G, 4G, fifth generation (5G) mobile networks, 3GPP, long term evolution (LTE), LTE advanced, enhanced data rates for GSM Evolution (EDGE), or the like. Other embodiments may be used in various other devices, systems, and/or networks.

The following examples pertain to further embodiments.

Example 1 may include a device comprising processing circuitry coupled to storage, the processing circuitry configured to: generate a first orthogonal frequency-division multiplexing (OFDM) signal to be transmitted in a frequency band; generate a second OFDM signal to be transmitted in the frequency band, wherein the second OFDM signal may be a duplicate of the first signal; assign a reduced number of guard intervals (GIs) to the first OFDM signal and the second OFDM signal; and cause to send the first OFDM signal and the second OFDM signal using the frequency band.

Example 2 may include the device of example 1 and/or some other example herein, wherein the first OFDM signal comprises a first number of GIs and the second OFDM signal comprises a second number of GIs.

Example 3 may include the device of example 2 and/or some other example herein, wherein the reduced number of GIs may be a subset of the first number of GIs and the second number of GIs.

Example 4 may include the device of example 1 and/or some other example herein, wherein the processing circuitry may be further configured to determine a signal power of the first OFDM signal and the second OFDM signal.

Example 5 may include the device of example 4 and/or some other example herein, wherein the signal power may be concentrated on a subset of subcarriers of the first OFDM signal and the second OFDM signal.

Example 6 may include the device of example 5 and/or some other example herein, wherein the signal to noise power ratio may be boosted around the subset of subcarriers.

Example 7 may include the device of example 1 and/or some other example herein, wherein the first OFDM signal may be repeated in a time domain and wherein a GI of the first signal may be removed.

Example 8 may include the device of example 1 and/or some other example herein, wherein the processing circuitry may be further configured not to insert pilot signals into the first OFDM signal or the second OFDM signal.

Example 9 may include the device of example 1 and/or some other example herein, further comprising a transceiver configured to transmit and receive wireless signals.

Example 10 may include the device of example 9 and/or some other example herein, further comprising an antenna coupled to the transceiver.

Example 11 may include a non-transitory computer-readable medium storing computer-executable instructions which when executed by one or more processors result in performing operations comprising: generating a first orthogonal frequency-division multiplexing (OFDM) signal to be transmitted in a frequency band; generating a second OFDM signal to be transmitted in the frequency band, wherein the second OFDM signal may be a duplicate of the first signal; assigning a reduced number of guard intervals (GIs) to the first OFDM signal and the second OFDM signal; and causing to send the first OFDM signal and the second OFDM signal using the frequency band.

Example 12 may include the non-transitory computer-readable medium of example 11 and/or some other example herein, wherein the first OFDM signal comprises a first number of GIs and the second OFDM signal comprises a second number of GIs.

Example 13 may include the non-transitory computer-readable medium of example 12 and/or some other example herein, wherein the reduced number of GIs may be a subset of the first number of GIs and the second number of GIs.

Example 14 may include the non-transitory computer-readable medium of example 11 and/or some other example herein, wherein the operations further comprise determining a signal power of the first OFDM signal and the second OFDM signal.

Example 15 may include the non-transitory computer-readable medium of example 14 and/or some other example herein, wherein the signal power may be concentrated on a subset of subcarriers of the first OFDM signal and the second OFDM signal.

Example 16 may include the non-transitory computer-readable medium of example 15 and/or some other example herein, wherein the signal to noise power ratio may be boosted around the subset of subcarriers.

Example 17 may include the non-transitory computer-readable medium of example 11 and/or some other example herein, wherein the first OFDM signal may be repeated in a time domain and wherein a GI of the first signal may be removed.

Example 18 may include the non-transitory computer-readable medium of example 11 and/or some other example herein, wherein the operations further comprise not insert pilot signals into the first OFDM signal or the second OFDM signal.

Example 19 may include a method comprising: generating, by one or more processors, a first orthogonal frequency-division multiplexing (OFDM) signal to be transmitted in a frequency band; generating a second OFDM signal to be transmitted in the frequency band, wherein the second OFDM signal may be a duplicate of the first signal; assigning a reduced number of guard intervals (GIs) to the first OFDM signal and the second OFDM signal; and causing to send the first OFDM signal and the second OFDM signal using the frequency band.

Example 20 may include the method of example 19 and/or some other example herein, wherein the first OFDM signal comprises a first number of GIs and the second OFDM signal comprises a second number of GIs.

Example 21 may include the method of example 20 and/or some other example herein, wherein the reduced number of GIs may be a subset of the first number of GIs and the second number of GIs.

Example 22 may include the method of example 19 and/or some other example herein, further comprising determining a signal power of the first OFDM signal and the second OFDM signal.

Example 23 may include the method of example 22 and/or some other example herein, wherein the signal power may be concentrated on a subset of subcarriers of the first OFDM signal and the second OFDM signal.

Example 24 may include the method of example 23 and/or some other example herein, wherein the signal to noise power ratio may be boosted around the subset of subcarriers.

Example 25 may include the method of example 19 and/or some other example herein, wherein the first OFDM signal may be repeated in a time domain and wherein a GI of the first signal may be removed.

Example 26 may include the method of example 19 and/or some other example herein, wherein the processing circuitry may be further configured not to insert pilot signals into the first OFDM signal or the second OFDM signal.

Example 27 may include an apparatus comprising means for: generating a first orthogonal frequency-division multiplexing (OFDM) signal to be transmitted in a frequency band; generating a second OFDM signal to be transmitted in the frequency band, wherein the second OFDM signal may be a duplicate of the first signal; assigning a reduced number of guard intervals (GIs) to the first OFDM signal and the second OFDM signal; and causing to send the first OFDM signal and the second OFDM signal using the frequency band.

Example 28 may include the apparatus of example 27 and/or some other example herein, wherein the first OFDM signal comprises a first number of GIs and the second OFDM signal comprises a second number of GIs.

Example 29 may include the apparatus of example 28 and/or some other example herein, wherein the reduced number of GIs may be a subset of the first number of GIs and the second number of GIs.

Example 30 may include the apparatus of example 27 and/or some other example herein, further comprising determining a signal power of the first OFDM signal and the second OFDM signal.

Example 31 may include the apparatus of example 30 and/or some other example herein, wherein the signal power may be concentrated on a subset of subcarriers of the first OFDM signal and the second OFDM signal.

Example 32 may include the apparatus of example 31 and/or some other example herein, wherein the signal to noise power ratio may be boosted around the subset of subcarriers.

Example 33 may include the apparatus of example 27 and/or some other example herein, wherein the first OFDM signal may be repeated in a time domain and wherein a GI of the first signal may be removed.

Example 34 may include the apparatus of example 27 and/or some other example herein, wherein the processing circuitry may be further configured not to insert pilot signals into the first OFDM signal or the second OFDM signal.

Example 35 may include one or more non-transitory computer-readable media comprising instructions to cause an electronic device, upon execution of the instructions by one or more processors of the electronic device, to perform one or more elements of a method described in or related to any of examples 1-34, or any other method or process described herein.

Example 36 may include an apparatus comprising logic, modules, and/or circuitry to perform one or more elements of a method described in or related to any of examples 1-34, or any other method or process described herein.

Example 37 may include a method, technique, or process as described in or related to any of examples 1-34, or portions or parts thereof.

Example 38 may include an apparatus comprising: one or more processors and one or more computer readable media comprising instructions that, when executed by the one or more processors, cause the one or more processors to perform the method, techniques, or process as described in or related to any of examples 1-34, or portions thereof.

Example 39 may include a method of communicating in a wireless network as shown and described herein.

Example 40 may include a system for providing wireless communication as shown and described herein.

Example 41 may include a device for providing wireless communication as shown and described herein.

Embodiments according to the disclosure are in particular disclosed in the attached claims directed to a method, a storage medium, a device and a computer program product, wherein any feature mentioned in one claim category, e.g., method, can be claimed in another claim category, e.g., system, as well. The dependencies or references back in the attached claims are chosen for formal reasons only. However, any subject matter resulting from a deliberate reference back to any previous claims (in particular multiple dependencies) can be claimed as well, so that any combination of claims and the features thereof are disclosed and can be claimed regardless of the dependencies chosen in the attached claims. The subject-matter which can be claimed comprises not only the combinations of features as set out in the attached claims but also any other combination of features in the claims, wherein each feature mentioned in the claims can be combined with any other feature or combination of other features in the claims. Furthermore, any of the embodiments and features described or depicted herein can be claimed in a separate claim and/or in any combination with any embodiment or feature described or depicted herein or with any of the features of the attached claims.

The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Certain aspects of the disclosure are described above with reference to block and flow diagrams of systems, methods, apparatuses, and/or computer program products according to various implementations. It will be understood that one or more blocks of the block diagrams and flow diagrams, and combinations of blocks in the block diagrams and the flow diagrams, respectively, may be implemented by computer-executable program instructions. Likewise, some blocks of the block diagrams and flow diagrams may not necessarily need to be performed in the order presented, or may not necessarily need to be performed at all, according to some implementations.

These computer-executable program instructions may be loaded onto a special-purpose computer or other particular machine, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a computer-readable storage media or memory that may direct a computer or other programmable data processing apparatus to function in a particular manner, such that the instructions stored in the computer-readable storage media produce an article of manufacture including instruction means that implement one or more functions specified in the flow diagram block or blocks. As an example, certain implementations may provide for a computer program product, comprising a computer-readable storage medium having a computer-readable program code or program instructions implemented therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, may be implemented by special-purpose, hardware-based computer systems that perform the specified functions, elements or steps, or combinations of special-purpose hardware and computer instructions.

Conditional language, such as, among others, “can,” “could,” “might,” or “may,” unless specifically stated otherwise, or otherwise understood within the context as used, is generally intended to convey that certain implementations could include, while other implementations do not include, certain features, elements, and/or operations. Thus, such conditional language is not generally intended to imply that features, elements, and/or operations are in any way required for one or more implementations or that one or more implementations necessarily include logic for deciding, with or without user input or prompting, whether these features, elements, and/or operations are included or are to be performed in any particular implementation.

Many modifications and other implementations of the disclosure set forth herein will be apparent having the benefit of the teachings presented in the foregoing descriptions and the associated drawings. Therefore, it is to be understood that the disclosure is not to be limited to the specific implementations disclosed and that modifications and other implementations are intended to be included within the scope of the appended claims. Although specific terms are employed herein, they are used in a generic and descriptive sense only and not for purposes of limitation.

What is claimed is:

1. A device, the device comprising processing circuitry coupled to storage, the processing circuitry configured to:
generate a first orthogonal frequency-division multiplexing (OFDM) signal to be transmitted in a frequency band;
generate a second OFDM signal to be transmitted in the frequency band, wherein the second OFDM signal is a duplicate of the first signal;
assign a reduced number of guard intervals (GIs) to the first OFDM signal and the second OFDM signal; and
cause to send the first OFDM signal and the second OFDM signal using the frequency band.

2. The device of claim 1, wherein the first OFDM signal comprises a first number of GIs and the second OFDM signal comprises a second number of GIs.

3. The device of claim 2, wherein the reduced number of GIs is a subset of the first number of GIs and the second number of GIs.

4. The device of claim 1, wherein the processing circuitry is further configured to determine a signal power of the first OFDM signal and the second OFDM signal.

5. The device of claim 4, wherein the signal power is concentrated on a subset of subcarriers of the first OFDM signal and the second OFDM signal.

6. The device of claim 5, wherein the signal to noise power ratio is boosted around the subset of subcarriers.

7. The device of claim 1, wherein the first OFDM signal is repeated in a time domain and wherein a GI of the first signal is removed.

8. The device of claim 1, wherein the processing circuitry is further configured not to insert pilot signals into the first OFDM signal or the second OFDM signal.

9. The device of claim 1, further comprising a transceiver configured to transmit and receive wireless signals.

10. The device of claim 9, further comprising an antenna coupled to the transceiver.

11. A non-transitory computer-readable medium storing computer-executable instructions which when executed by one or more processors result in performing operations comprising:
generating a first orthogonal frequency-division multiplexing (OFDM) signal to be transmitted in a frequency band;
generating a second OFDM signal to be transmitted in the frequency band, wherein the second OFDM signal is a duplicate of the first signal;
assigning a reduced number of guard intervals (GIs) to the first OFDM signal and the second OFDM signal; and
causing to send the first OFDM signal and the second OFDM signal using the frequency band.

12. The non-transitory computer-readable medium of claim 11, wherein the first OFDM signal comprises a first number of GIs and the second OFDM signal comprises a second number of GIs.

13. The non-transitory computer-readable medium of claim 12, wherein the reduced number of GIs is a subset of the first number of GIs and the second number of GIs.

14. The non-transitory computer-readable medium of claim 11, wherein the operations further comprise determining a signal power of the first OFDM signal and the second OFDM signal.

15. The non-transitory computer-readable medium of claim 14, wherein the signal power is concentrated on a subset of subcarriers of the first OFDM signal and the second OFDM signal.

16. The non-transitory computer-readable medium of claim 15, wherein the signal to noise power ratio is boosted around the subset of subcarriers.

17. The non-transitory computer-readable medium of claim 11, wherein the first OFDM signal is repeated in a time domain and wherein a GI of the first signal is removed.

18. The non-transitory computer-readable medium of claim 11, wherein the operations further comprise not inserting pilot signals into the first OFDM signal or the second OFDM signal.

19. A method comprising:
generating, by one or more processors, by one or more processors, a first orthogonal frequency-division multiplexing (OFDM) signal to be transmitted in a frequency band;
generating a second OFDM signal to be transmitted in the frequency band, wherein the second OFDM signal is a duplicate of the first signal;
assigning a reduced number of guard intervals (GIs) to the first OFDM signal and the second OFDM signal; and
causing to send the first OFDM signal and the second OFDM signal using the frequency band.

20. The method of claim 19, wherein the first OFDM signal comprises a first number of GIs and the second OFDM signal comprises a second number of GIs.
